(19) United States
(12) Patent Application Publication
(10) Pub. No.: US 2012/0097712 A1
(43) Pub. Date: Apr. 26, 2012

(54) Packaging Element With A Hermetically Sealed Dosing Mechanism For Semi-Solid Products

(76) Inventors: Victor Esteve, São Paulo-SP (BR); Eric Zembrod, Boituva-Sp (BR)

(21) Appl. No.: 13/322,767

(22) PCT Filed: Dec. 23, 2009
(86) PCT No.: PCT/BR09/00435

§ 371 Date: Nov. 28, 2011

(30) Foreign Application Priority Data
Jan. 15, 2009 (BR) PCT/BR2009/000008

(51) Int. Cl. G01F 11/00

(52) U.S. Cl. 222/390

(57) ABSTRACT

Packaging element with a hermetically sealed dosing mechanism for semi-solid products, comprehending its body as a sole piece (10) injected in plastic material, configuring two concentric parts, one internal that configures the product containing cup-like recipient (11) and an external which configures a skirt for optional finishing (12), both with their top endings integrated between themselves by a horizontal wall (13), above which emerge vertically two concentric collars (14) and (15), which configure a hermetical coupling for a device in the shape of a spinning disc (16) that rotates in only one direction and always in the same plane in relation to the main body (10), and whose spinning disc (16) outside portion, may receive an optional over-lid (17), while from its inside portion has constructive details integrated to the assembly of an integrated protection dosing valve mechanism (18) and an actioning mechanism (19) for a piston (20) that, by its turn, initially (full package) is placed along with the bottom (21) of the cup-like recipient (11) containing the product (P).

### FIELD OF THE INVENTION

The invention herein, more particularly refers to a packaging element with a cup-like recipient for containing different semi-solid products (from low to high viscosity), such as, for example, some kinds of pharmaceuticals, cosmetics or chemicals which, in general are presented in the form of creams, pastes or gels.

### BRIEF DESCRIPTION OF THE INVENTION

The cup-like recipient, containing the product, includes a piston connected to a dosing mechanism formed by a screw rod attached to a spinning disc, this last being responsible for the hermetic sealing of the cup-like recipient.

The hermetic dosing device is also integrated by an optional over-lid.

The spinning disc is designed to rotate always in the same plane in relation to the main body to keep the hermetic sealing, and, at the same time, rotates the screw element, activating in such a way the upward displacement of the piston, which applies pressure on the product located in the inner portion of the cup-like recipient, forcing it into a dosing chamber and, through a control valve system (obturator), that when in rendered active, releases a dose of the product over an existing depression on the top center part of said spinning disk, from where it is removed manually.

The protective valve system (described in this patent as an “obturator”) located at the outlet of the cup-like recipient is overcome by the product only after a determined pressure is applied, and at this moment, a certain amount of product flows through the same, and through the outlet nozzle, placing itself on a depression at the center of the spinning disc.

The release of the product (complete dose output) occurs up to the extent were the internal pressure is reduced to a point where the valve system is tightly sealed again.

Therefore, during the actioning of the dosing mechanism, no external air inlet is allowed inside the system and, therefore direct contact of the product with the external air is also avoided, characterizing a hermetically (tight) sealed way of dispensing.

Through a carriage system, the spinning disc, along with the cup-like recipient, allows the release of controlled doses and, at the same time, prevents the backward rotation of such disc.

### STATE OF THE TECHNIQUE

Currently there are different packing elements for similar use, such as those taught in the documents: DE 3936449, DE 202005003825, EP 0580512, EP 0787445, FR 2681767, FR 2816813 and FR 2876257.

Doubtless such packing elements grant means for containing different cosmetic and pharmaceutical products, nevertheless they do not present an hermetically sealed (tight) functioning concept, therefore the hermetic condition obtained for such sets are limited only to the retention of the product not avoiding the external air inlet and direct contact of the product with the external environment during the dispensing process, consequently the product must have a quantity of preserving agents and other chemical substances to avoid its oxidation and degradation during its life time and use.

### OBJECTS OF THE INVENTION

The first objective of the invention is an hermetic packing element with a precise dosing system and with a cup-like recipient compartment to contain various forms of semi-solid products (of high and low viscosity), traditionally none as creams, pastes or gels, such as, for example: some cosmetics and pharmaceutical products or other chemical formulations which requires precise dosing application and adequate storage to secure an indication of use and to maintain the product's stability during life-time (shelf-life time) and during use.

Another objective of the invention is to combine a cup-like recipient hermetic sealed, associated with an actioning system functioning by mechanical pressure, avoiding inlet of air into the system at any condition, keeping the system hermetically sealed (tight) on and off-use.

Such characteristics are necessary to protect the product to be dosed against oxidation or contamination exposure during storage time and use.

The hermetic concept of such container has also the objective to allow reduction of preserving agents in cosmetic or pharmaceutical formulations, since there is no direct contact of the contents with the exterior environment, ensuring an efficient way for storing and using the product.

Such hermetic concept has also the objective of making it possible to extend the life time of products with less quantity of preserving agents, or which active ingredients and excipients are volatile or sensitive to oxygen.

The packing system is preferably manufactured with plastic resins compatible among themselves to allow total recycling of the packing set after its use.

Still, such packaging concept enables the handling of the set in a more practical and economic way for the filling of its content (product) at any production scale and to permit several external variations of design, and also allow the final consumer to have maximum efficiency for the use of its contents, leaving a minimum residual volume inside the system when empty.

In the invention, the packing system hermetic sealing is ensured by a set of components which conforms in a single body, not dependable of a protecting lid (over-placed to the system) to ensure a perfect hermetic sealing of its inner portion.

The sealing is ensured in four critical points perfectly designed to offer the necessary hermetic sealing parameters, with preferably one or more sealing connections (protection barriers) in each critical point in order to avoid inlet of external air into the system and direct contact of the product with the external environment when the mechanism is on or off use and during product dose release.

In one variation of the present invention a cup-like recipient is used in a refill version, not with the objective of reducing preserving agents in the product (formulation), but as a safe mean for storing and dosing semi-solid products with significant reduction of the package environmental impact.

The refill mode has the further objective to make the packaging system comply with the current ecological criteria for granting it the label “ecological friendly” with reduction of the environmental impact according to criteria of RPT (Ratio/Product/Tare), number of times that the package is re-used and correct use of dosages (without waste), according with Annex 9 of the European Community Decision Commission from Brussels, published in the Official European Union Journal in Jun. 26, 2007, notified with number C(2007)3127.

### BRIEF DESCRIPTION OF THE DRAWINGS

For a better understanding of the present invention, a detailed description is provided below, with reference to the attached drawings, where:

FIG. 1—Shows a perspective from a superior angle;

FIG. 2—Shows another perspective, although from an inferior angle;

FIG. 3—Shows a lateral view;

FIG. 4—Show a view in transversal cut and a top view also in cut, above the line indicated in the previous figure;

FIG. 5—Exhibits an exploded perspective from a superior angle;

FIG. 6—Reproduces another exploded perspective, although, from a inferior angle;

FIG. 7—Is a partial view, in transversal cut, and various details magnified in perspective;

FIG. 8—Shows another side view in cut and one respective detail magnified;

FIG. 9—Represents a magnified detail from the view in cut of FIG. 8;

FIG. 10—Shows a partial view, in exploded magnified perspective, with details from the protection dosing valve set and spinning disc;

FIG. 11—Represents a partial perspective view from a superior angle, showing in an exploded form, the details of the spinning disc actioning set;

FIG. 12—Is a view of the assembled set an in cut, and also a perspective view in cut from a superior angle, in exploded way, of the actioning set with details of piston and cup-like recipient;

FIG. 13—Shows a similar exploded perspective and in cut as in FIG. 12, although from an inferior angle.

FIG. 14—Shows a side view in cut of another constructive option for the top portion of the package system;

FIG. 15—Shows a side view in cut of the constructive variation for the refill mode package version;

FIG. 16—Reproduces an exploded perspective view from a superior angle showing the refill package version;

FIG. 17—Shows a similar exploded perspective from the refill package version as in FIG. 16, although, from an inferior angle;

FIG. 18—Shows a perspective view in cut placing in the spotlight the permanent set and beneath the complete refill package set with the removable seal;

FIG. 19—Shows from a superior angle a perspective view of the package with the actioning system through the base;

FIG. 20—Shows a side view of the package similar to the previous figure;

FIG. 21—Shows from an inferior angle a perspective view of the package with the actioning system through the base;

FIG. 22—Shows a side view in cut of the package with the actioning system from the base;

FIG. 23—Shows a perspective exploded view from a superior angle of the package with bottom actioning;

FIG. 24—Shows a similar view as in FIG. 23, although in transversal cut and with magnified details;

FIG. 25—Exhibits a perspective exploded view from an inferior angle of the package with the actioning system from the base;

FIG. 26—Shows a view in transversal cut of the version without refill, although, with details of another constructive version for the sealing between the spinning disc and the body which configures the cup-like recipient and the finishing cover or skirt;

FIG. 27—Shows a magnified detail of the previous figure highlighting the constructive variation of said sealing;

FIG. 28—Represents a view in transversal cut of the refill version, although, with details of other constructive version for the sealing between the spinning disc and the body which configures the cup-like recipient and the finishing cover; and

FIG. 29—Shows a magnified detail of the previous figure, highlighting the constructive version of said sealing of the refill version.

FIGS. 30 and 31 represent perspectives from different angles showing a constructive variation of the valve;

FIGS. 32 and 33 show exploded perspectives of the second constructive version of the valve;

FIGS. 34 and 35 illustrate exploded, cut-way perspectives and amplified details, also cut-way, highlighting the constructive details of the second constructive version of the valve;

FIG. 36 is a side, cut-way view of the spinning disk with the valve of the second constructive version;

FIG. 37 shows a cut perspective of the packaging shows a cut-way of the packaging assembled with the second constructive version of the valve;

FIGS. 38 and 39 represent perspectives from different angles showing the third constructive variation of the valve;

FIGS. 40 and 41 show exploded perspectives of the third constructive version of the valve;

FIGS. 42 and 43 illustrate exploded, cut-way perspectives and amplified details, also cut-way, highlighting the constructive details of the third constructive version of the valve;

FIG. 44 is a side cut-view of the spinning disk with the valve of the third constructive version; and a

FIG. 45 shows a cut-way perspective of the packaging assembled with the third constructive version of the valve.

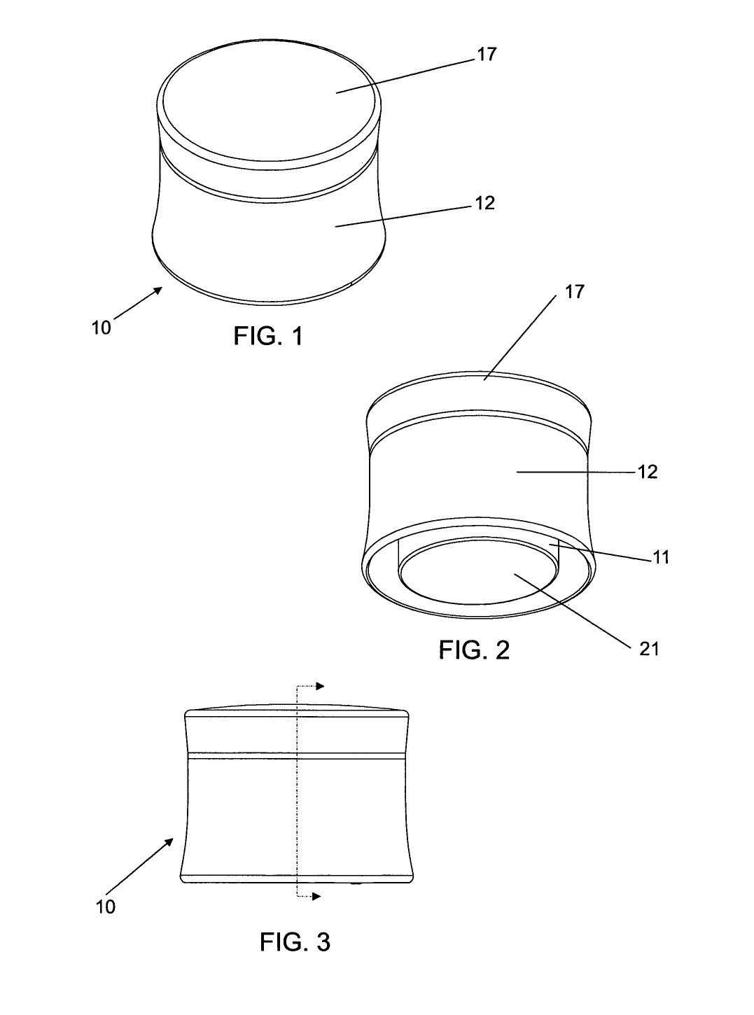

### DETAILED DESCRIPTION OF THE INVENTION

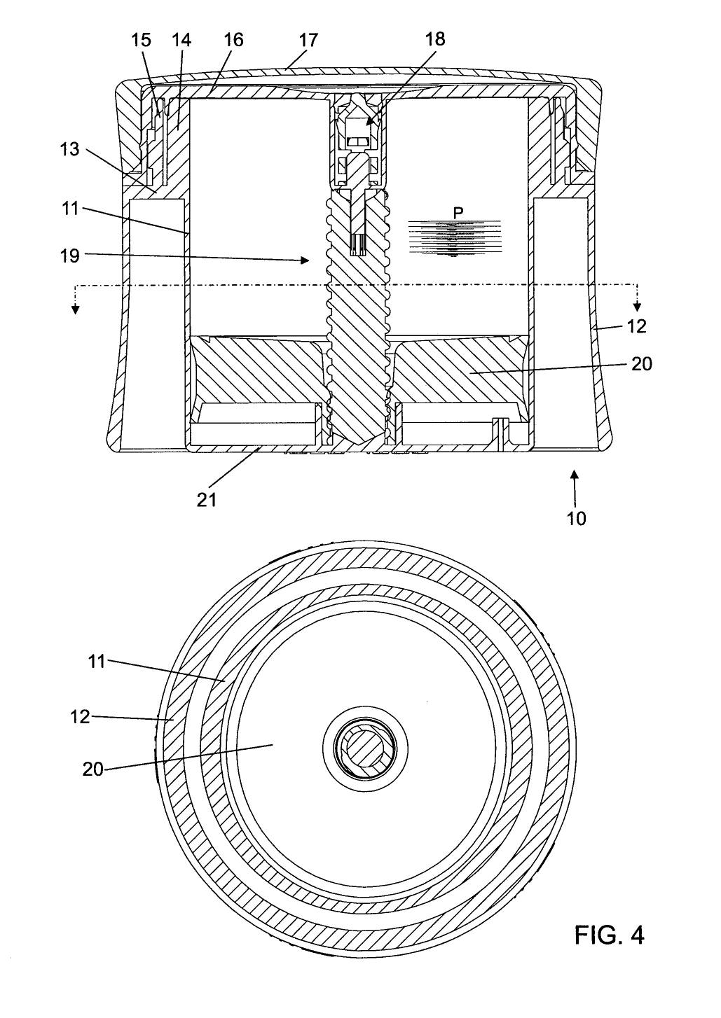

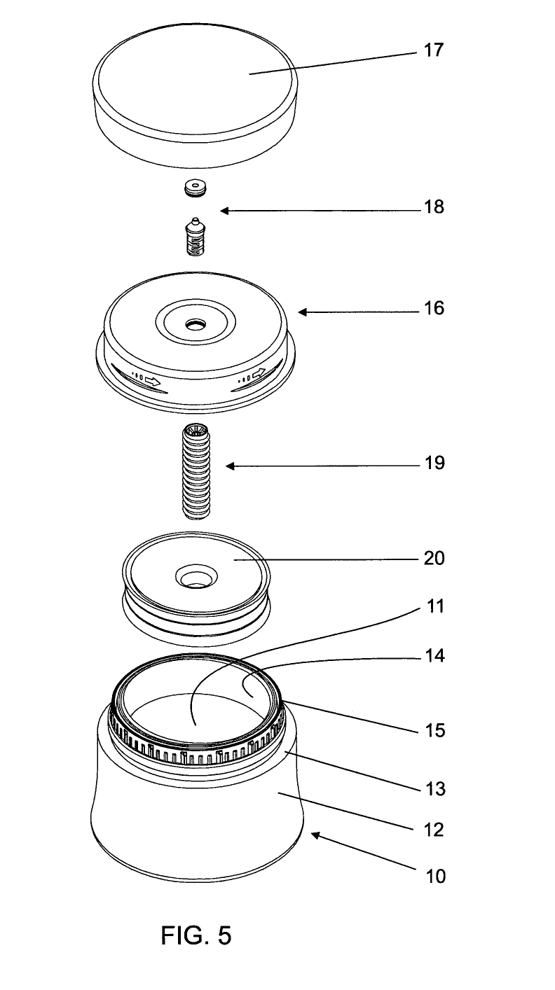

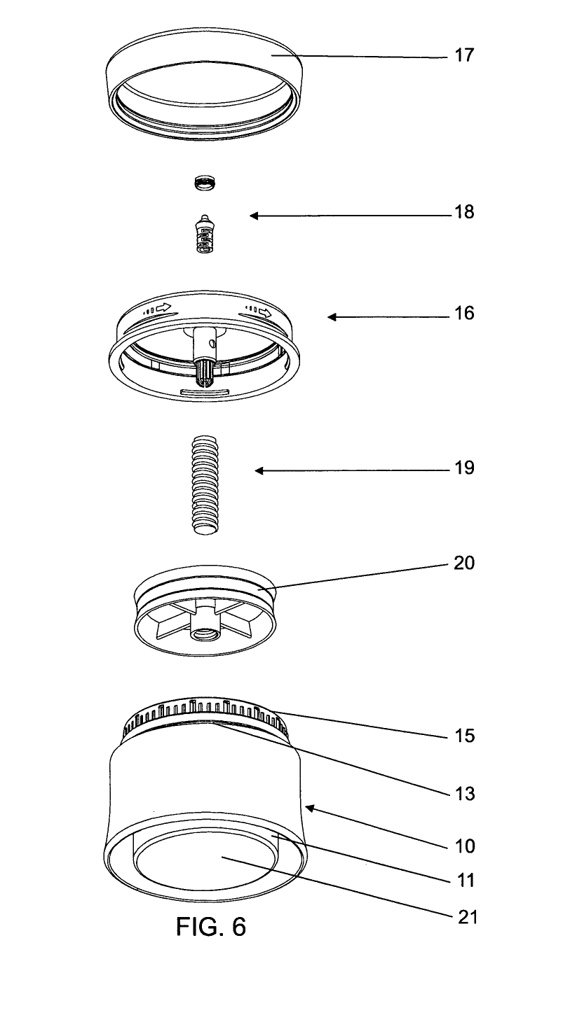

According to these illustrations and in their details, more particularly the figures from 1 to 6, the present invention PACKAGING ELEMENT WITH A HERMETICALLY SEALED DOSING MECHANISM FOR SEMI-SOLID PRODUCTS, is characterized by the fact that it comprehends a body as a sole piece (10) injected in plastic material, configuring two concentric parts, one internal that configures the product containing cup-like recipient (11) and an external which configures a skirt for optional finishing (12), both with their top endings integrated between themselves by a horizontal wall (13), above which emerge vertically two concentric collars (14) and (15), which configure a hermetical coupling for a device in the shape of a spinning disc (16) that rotates in only one direction and always in the same plane in relation to the main body (10), and whose spinning disc (16) outside portion, may receive an optional over-lid (17), while from its inside portion has constructive details integrated to the assembly of an integrated protection dosing valve mechanism (18) and an actioning mechanism (19) for a piston (20) that, by its turn, initially (full package) is placed along with the bottom (21) of the cup-like recipient (11) containing the product (P), where said piston spinning is avoided by the fact that the internal diameter of the cup-like recipient (11) (FIG. 4) is slightly oval, although, said piston (20) is operatively assembled to be displaced only upwards upon activating the spinning disc (16) and, along with, the mechanism (19), in a way that the said piston may apply enough pressure to the product (P) placed above it, to open the dosing valve (18) and allow exact dosages of the product to be dispensed above the said spinning disc (16) on to a surface (39) where it can be removed with the fingers for application.

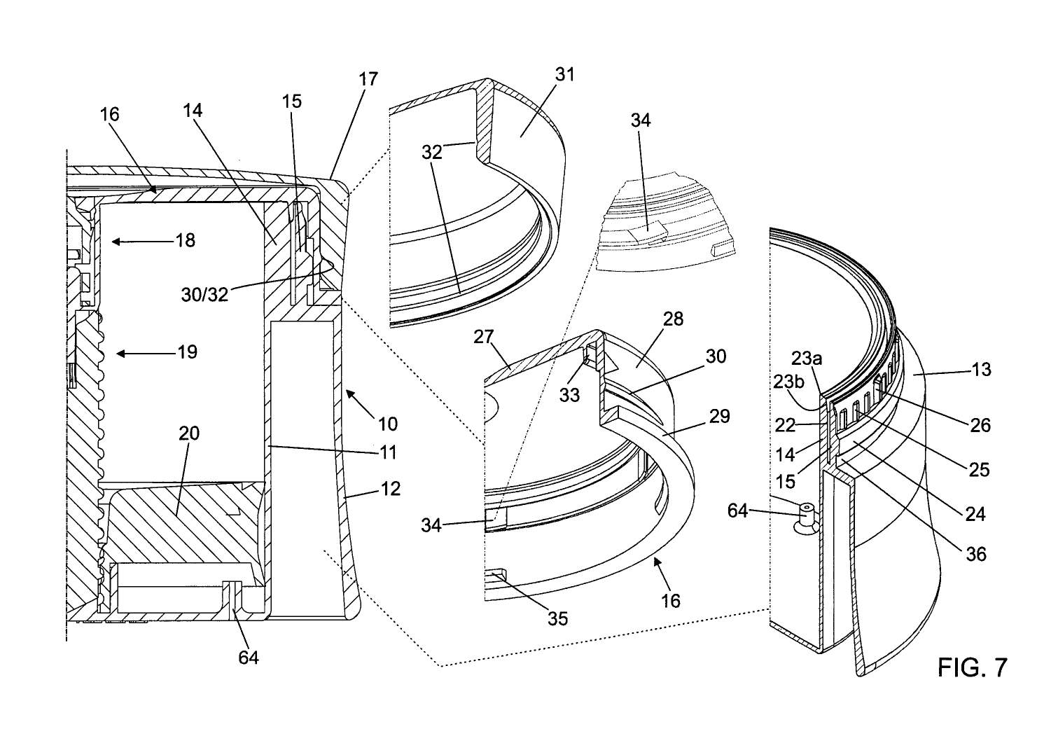

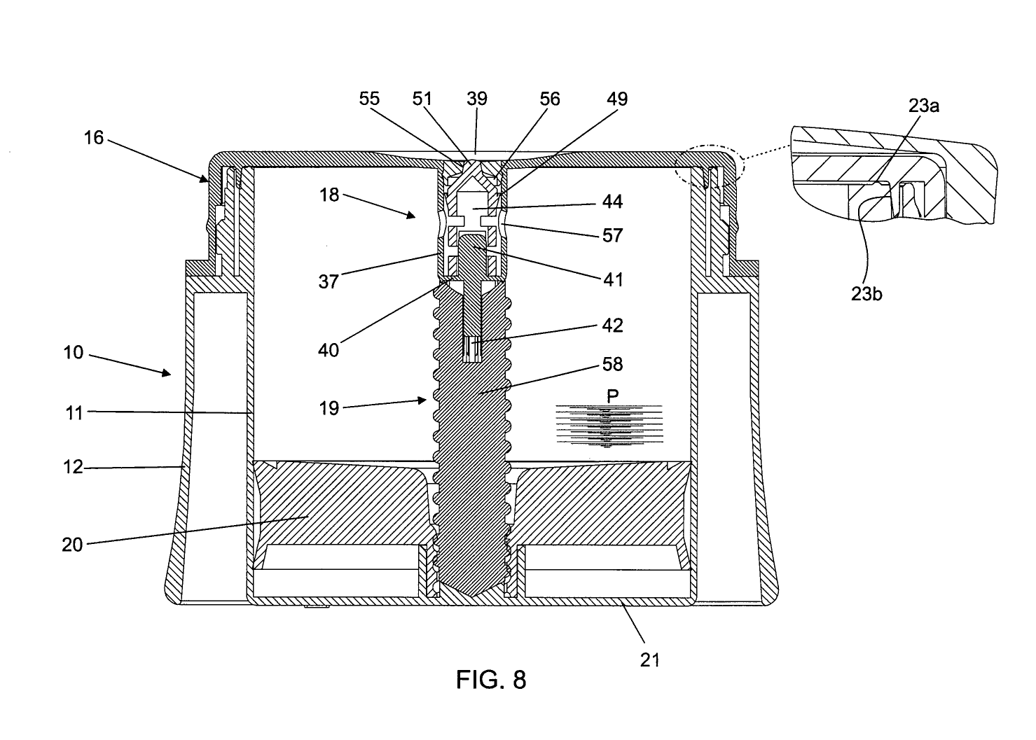

According to what illustrates the FIGS. 7 and 8, the two collars (14-15) present means for a hermetic coupling of the spinning disc (16) and means for the spinning disc to rotate always in the same plane in relation to the body (10) and only in one sense, preferably anti-clockwise. For that, initially the two collars (14-15) are enough concentrically apart one to the other to form a void (22), where the top edge of the internal collar (14) presents details of a circular closing ring in the shape of a top nervure (23a) and a cut (23b) placed in ramp towards the interior of the void (22), while the other external collar (15) presents in its external diameter two details in which the first one is a circular ring protrude (24), like a flange, above which there is a collar of smaller equidistant teeth (25) spaced apart in groups by other similar teeth, although larger (26), configuring a rotational turnstile control for advance of the spinning disc (16), that is turned, by the horizontal superior wall (27) an the a vertical cylindrical skirt (28), this last, having its bottom edge projected outwards in the shape of a flange (29) with diameter to lay on that portion of the wall (13), and, still, on the diameter of the said spinning disc (16) there are smooth locking fillets (30) for the seating of an optional over-lid (17) which, by the internal side of its skirt (31) it has a continuous smooth coupling groove (32) to seat on said filets (30) of the spinning disk (16) which, still, has two details for hermetic closing, in which, the first is a concentric cylindrical lip of reduced height practically in the shape of a circular guide, or track (33), which diameter is something to penetrate with interference in the void (22) and to be tensioned over the cut (23b), while at the second point of hermetic closing the bottom surface of the spinning disc (16) makes a certain pressure on the circular closing ring or top nervure (23a) located on the upper part of the collar (14), allowing an hermetic coupling for its closure type spinning disc.

The spinning disc (16) presents other internal details constituted by a collar of flexible equidistant tabs (34), slightly bent and oriented to slide on a carriage formed by the teeth (25) and (26) such sliding occurs in only one direction, since in the contrary sense, the edge of the tabs have the teeth (25-26) as barriers, being that, still in the internal portion of the spinning disc (16) includes a collar of coupling projections (35) with a trapezoidal transversal section dimensioned and oriented to be inserted in the groove (36) formed between the ring salience (35) and that wall (13), establishing, in this way a sliding coupling for the spinning disc (16), in a way that it is kept permanently over pressured against the body (12), as well as being turned in only one direction, and always in the same plane in relation to the body (12) to secure its sealing.

The interference between the coupling projections (35) of the spinning disc (16) and the ring salience (24) of the body (12) determines the sealing pressure over the sealing ring or to nervure (23a) against the inferior face of the spinning disc (16) and the lip tensioning (33) at the wall of the groove (22), characterizing, is such a way, the necessary sealing during the disc spinning (16).

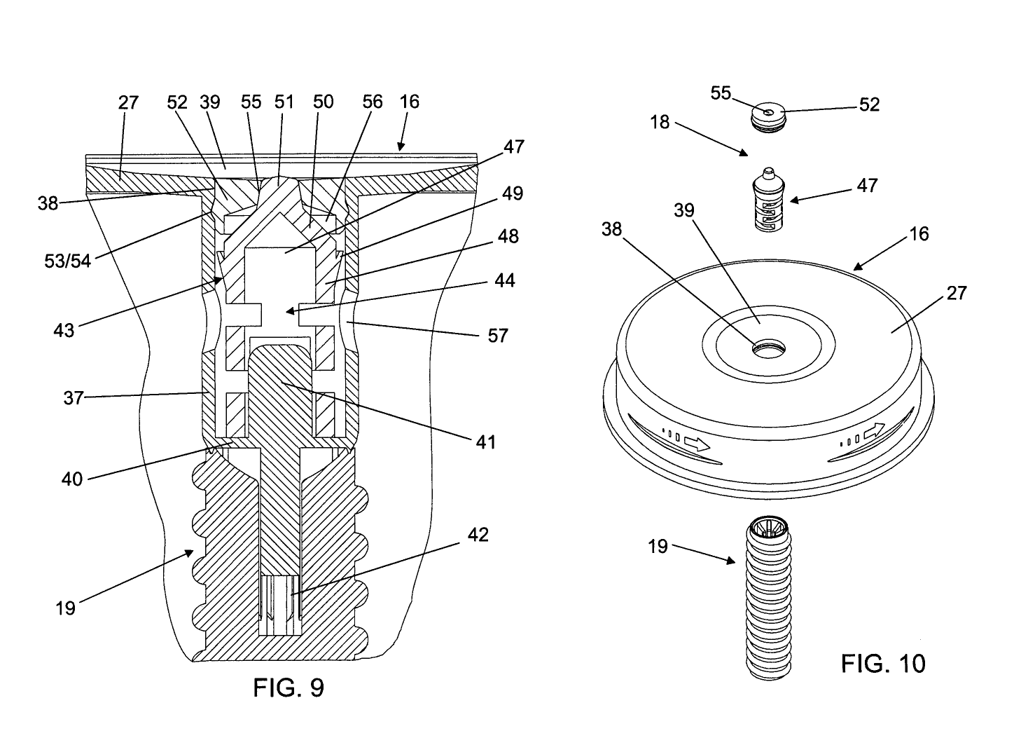

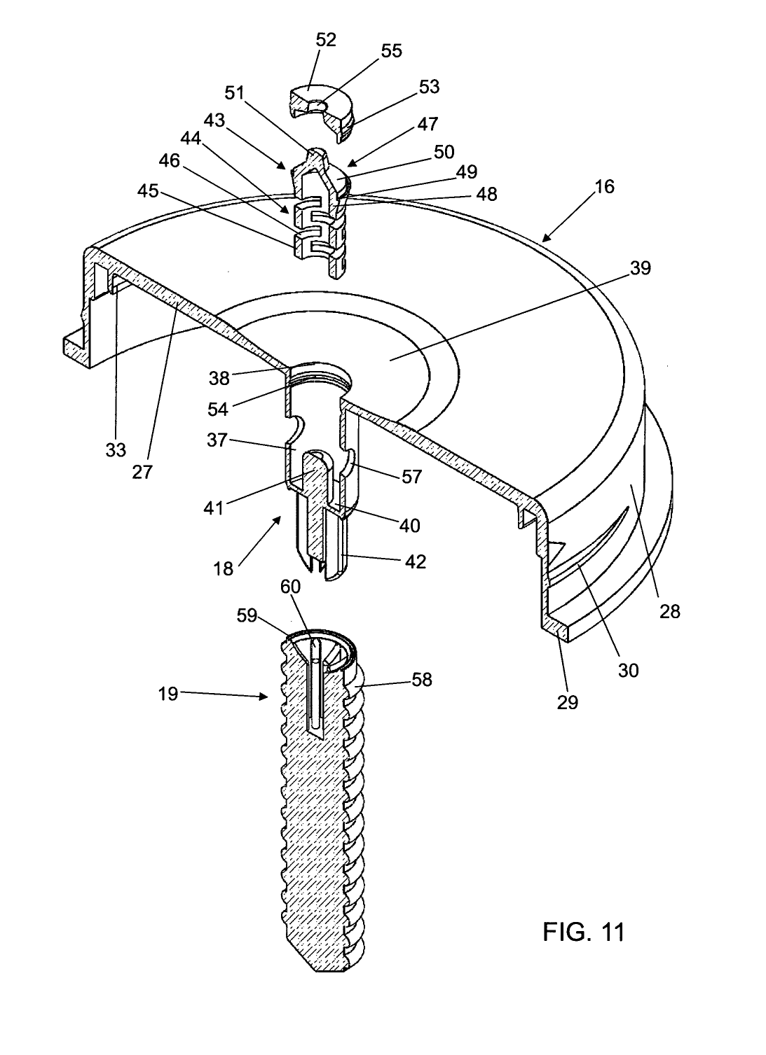

The dosage protection valve mechanism (18) details are illustrated in the FIGS. 8 to 11, through which it is possible to verify that it presents a tubular dosing chamber (37), which top end is completely opened and is integrated with the wall (27) of the spinning disc (16), configuring an opening (38) whose top portion is circumscribed by a recess ordinarily shaped in form of a shell (39) for accumulation of the product's (P) dose, while through the bottom end, the tubular dosing chamber (37) is completely sealed by a wall (40), which is centrally crossed by an integrated projection defined by two edges, one internal cylindrical on the top (41) and one external finned (42) on the bottom, this last one constitutes a coupling for the actioning mechanism (19) and the piston (20) while the other (41) constitutes a coupling point for stabilizing an obturator (43) which is formed in one sole piece defined by two parts, a bottom portion with a spring-like function (44) formed by a section ordinarily tubular (45) with several cuts (46) and a superior part defined as a sealing lid (47), having a section ordinarily cylindrical (48) which constitutes the top end of said spring (44), such cylindrical section has a collapsible sealing lip (49) which slides with interference (or tension) at the internal diameter of the dosing chamber (37), and above said sealing lip (49), the cylindrical section (48) has an accentuated narrowing with a conic-shape (50) which ends in a point equally conic (51), which is oriented to penetrate in a sealing insert (52), this last with its external diameter endowed with a circular locking fillet (53) which penetrates in a groove equally circular (54) existing in the dosing chamber internal diameter (37) and along with an opening (38) where said insert is firmly locked, as well as, equipped with a conic central nozzle (55) for the product outlet, although, normally closed by the tip of the sealing lid (51) permanently pressed upwards by the spring-like part (44), although such closing occurs in a way that between the sealing (49) and the lid (47), as well as above the sealing lip (49) forms an access area (56) for the product (P) which arrives to the inner part of the valve (18) through one or more radial passages (57) existing at the wall of the dosing chamber (37), where the pressure of the product (P) overcomes the spring pressure (44) and makes the sealing tip (51) to be temporarily displaced downwards releasing the nozzle (55) enough for one dose of the product (P) to be deposited on the recess (39), returning to close the outlet orifice nozzle (55) immediately after the internal pressure is compensated through the dosage release.

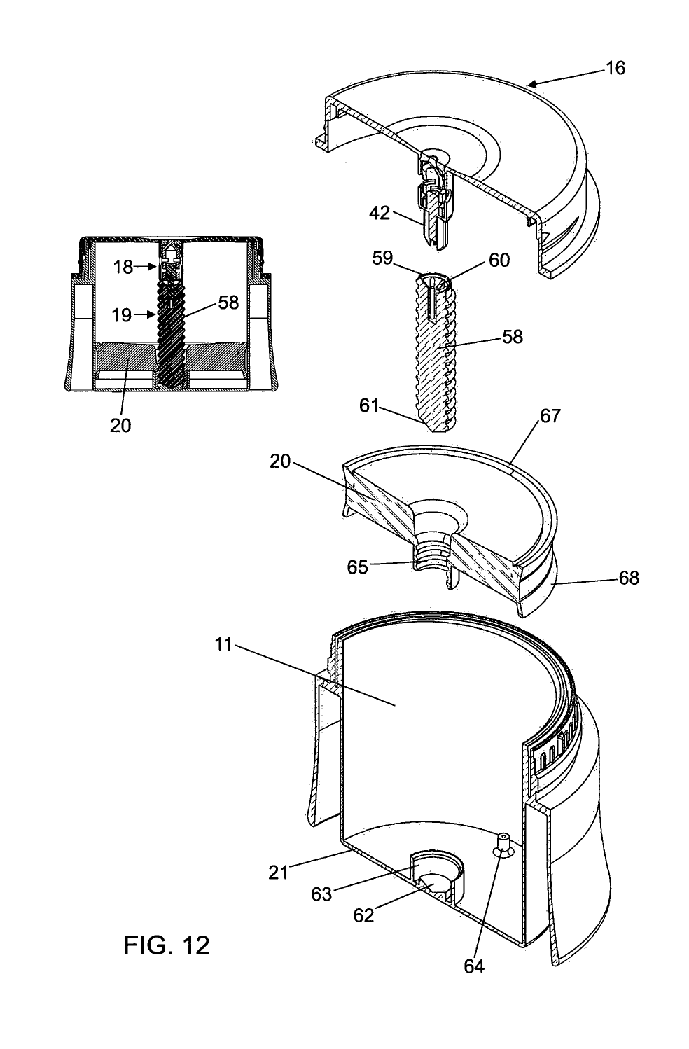

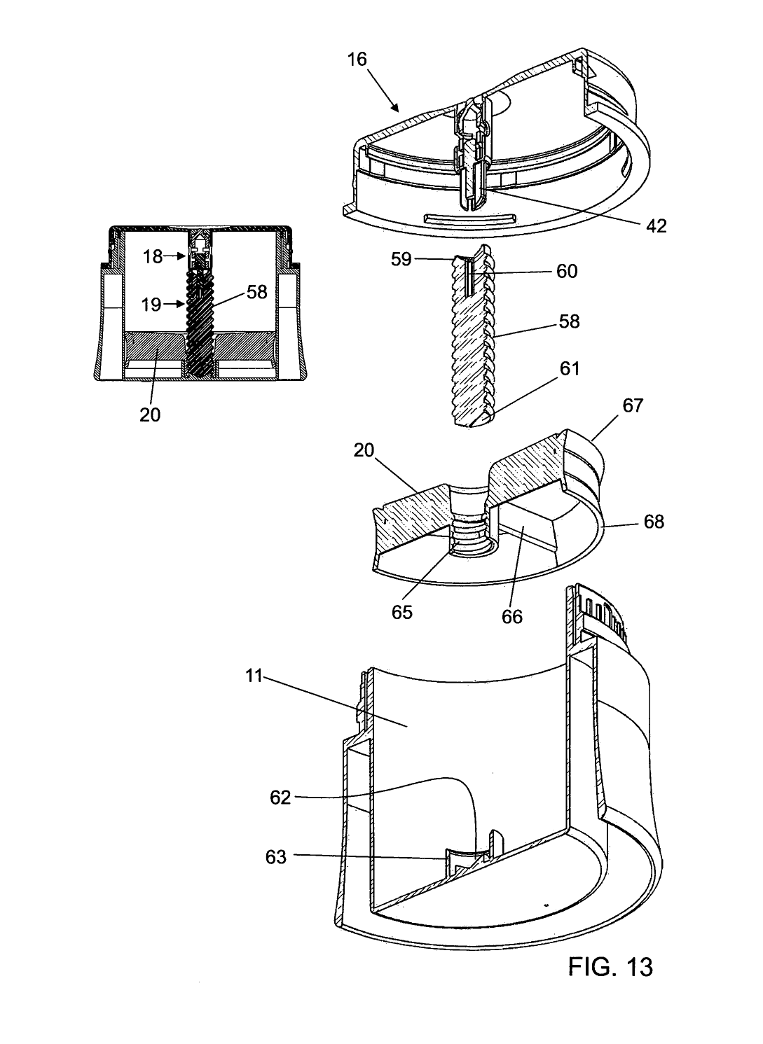

The activating mechanism (19) is illustrated in details in FIGS. 12 and 13, where it can be verified that the activating mechanism (19) is formed by a screwed-rod (58), which presents on its top part a short tubular section (59) having in its inner portion radial fins (60) in between which those others fins (42) located in the under center part of the spinning disc (16) penetrates, in a way that both screw-rod (58) and spinning disc (16) may be solitarily bonded while the bottom end of the said screwed-rod (58) has a conic shape (61) to lay over an equally centered projection with its top part shaped also in a conic manner (62), which is circumscribed by a short tubular portion (63) which emerges from the internal bottom wall (21) in the internal part (11) of the cup-like recipient where there is a anti-vacuum opening (64), being that, as already explained, next to the said bottom, the piston (20) is positioned, having it a central hole with an internal screw (65) elongated downwards to be coupled between the seat (62) and the wall (63) from where said piston (20) begins its upwards displacement and also, on its bottom portion radial bars (66) are placed for a balance structuring of its external diameter, where top and bottom edges form sealing lips (67-68) which remain permanently pressured against the internal diameter of the cup-like recipient (11) to ensure the hermetic sealing in this point.

Once the screwed-rod (58) is positioned with some interference inside the internal screw (65) of the piston, the hermetic sealing of the system in this point is ensured with at least one complete turn of the screw (pace) while the system (package) is not activated (self-life), and with at least one or more complete turns of the screw (pace) when the system is once activated.

In this constructive configuration, the hermetic sealing is also ensured at this point by the fact that the filet of the screw-rod (58) is perfectly equal to the screw pace (65) in the center of piston (20).

The functioning of the package, as described, is really very simple, since as it has already been said (FIGS. 7 and 8), the spinning disc (16) is developed to suffer successive displacements in one sole sense/direction, as if an engine movement (pace), being that each rotational advance movement (pace) generates a dose, the rotation movement (pace) is sensed by the user at each displacement over the main teeth (26) being that the smaller intermediate teeth (25) are responsible for not allowing the disc (16) to rotate in the contrary direction between dosages.

The volume (grams) of the released (dosage), at each rotation over each teeth (26), can be determined by the screw turn (pace) (58/65) and by the area of product (P) contained above the piston (20).

In this manner, to withdraw one dose, the user must apply a displacement (pace) at the spinning disc (16), and as a consequence, the turn is applied to the piston (20) through the screwed-rod (58), making said piston to be displaced upwards.

Although this movement is reduced, it is enough to create pressure in the inner part of the cup-like recipient (11) or pressure over the product (P), which has only as escape point the hole or holes (57) placed at the dosage chamber (37).

The product invades the inner portion of the valve (18) and pressures the point of sealing in shape of a lip (49), which profile is projected to give in when this pressure exists, allowing the product to flow into the interior of the access area (56).

At this stage, the product (P) that already flowed into the dosing chamber (37) applying pressure on the obturator (43), passing the sealing lip (49), forces it downwards against its spring-like portion (44) due to its elasticity, and since the spring-like part is placed in the opposite part from of the obturator tip (51) it consequently recedes momentarily from the outlet nozzle (55) so that the product (P) dose may get out and be deposited at that cavity (39), where it is manually removed by the user.

The product flow occurs while the internal pressure generated by the advance of the piston (20) is superior to the strength of the spring (44) because, on the contrary situation, said spring (44) forces the tip (51) of the obturator (43) immediately to close the outlet nozzle (55), at the same time, the sealing lip (49) also returns to its original position with tension against the internal diameter of the tubular dosing chamber (37) of the valve (18), finalizing, in such a way, a hermetic dosage dispensing system without back-stream of product or residual product left on the nozzle, and also as noticed to be impossible to occur inlet of external air in the system during actioning, when being used, and off-work.

The anti-vacuum opening (64) exists only to avoid generation of vacuum bellow the piston (20), what would impair its displacement upwards in the inner portion of the cup-like recipient.

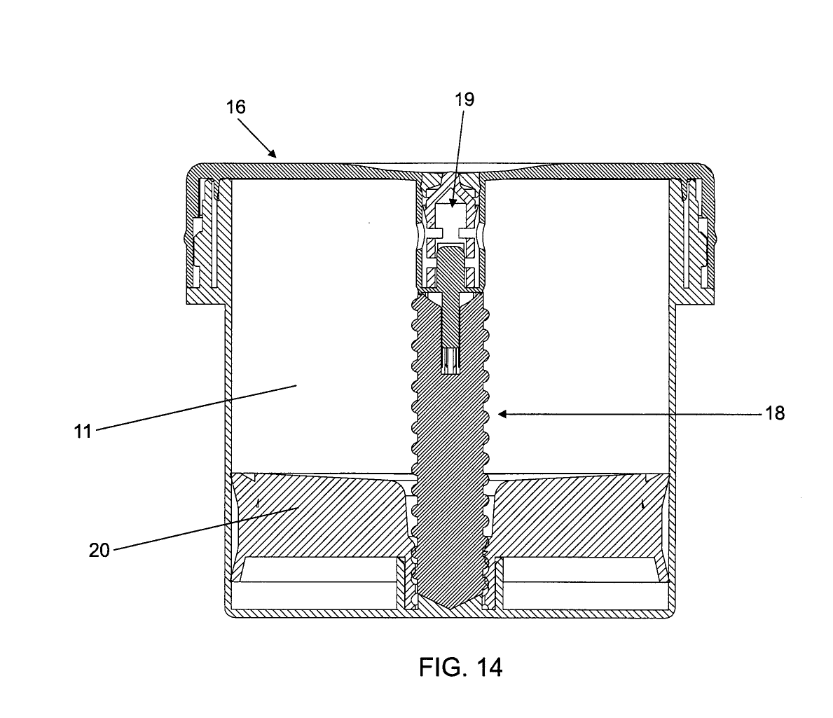

FIG. 14 exemplifies the fact that the finishing skirt or cover or support (12) of the cup-like recipient (11) illustrated in the previous Figures is an item which constructive details may vary considerably to define any decorative or utility design, as well as said finishing cover or skirt is optional, consequently, may be completely eliminated without altering the functioning and the advantages of the set.

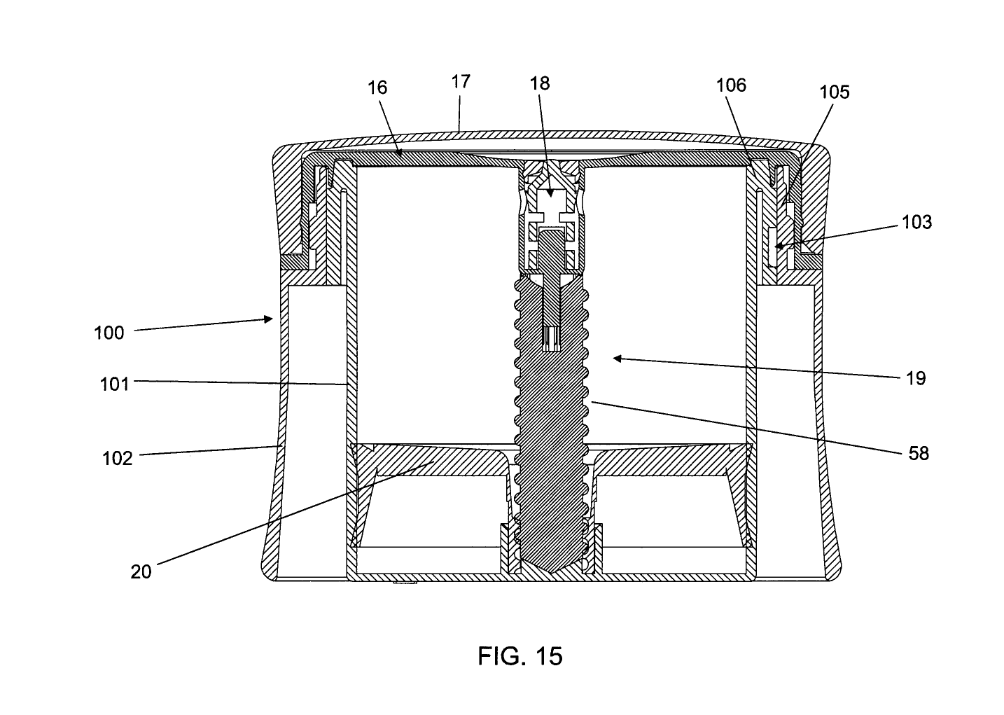

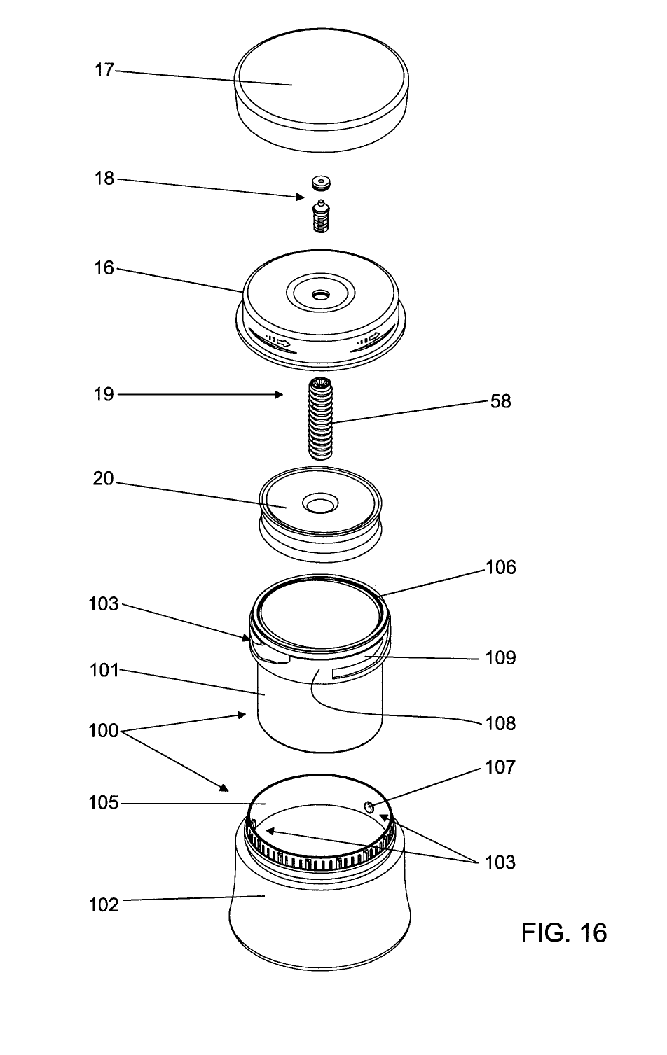

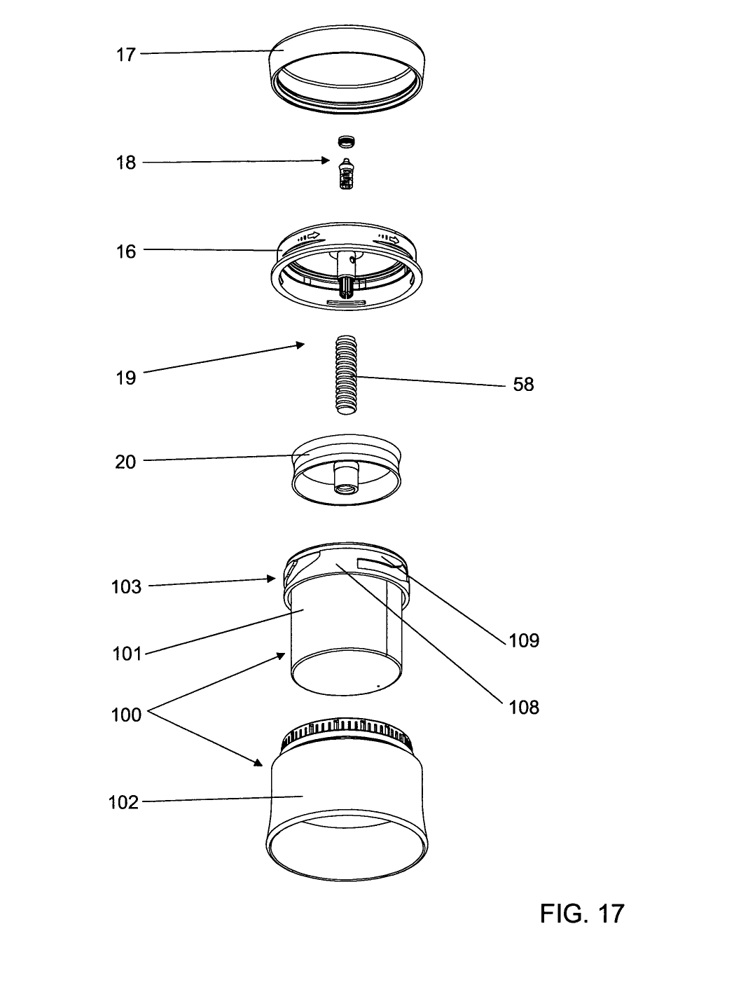

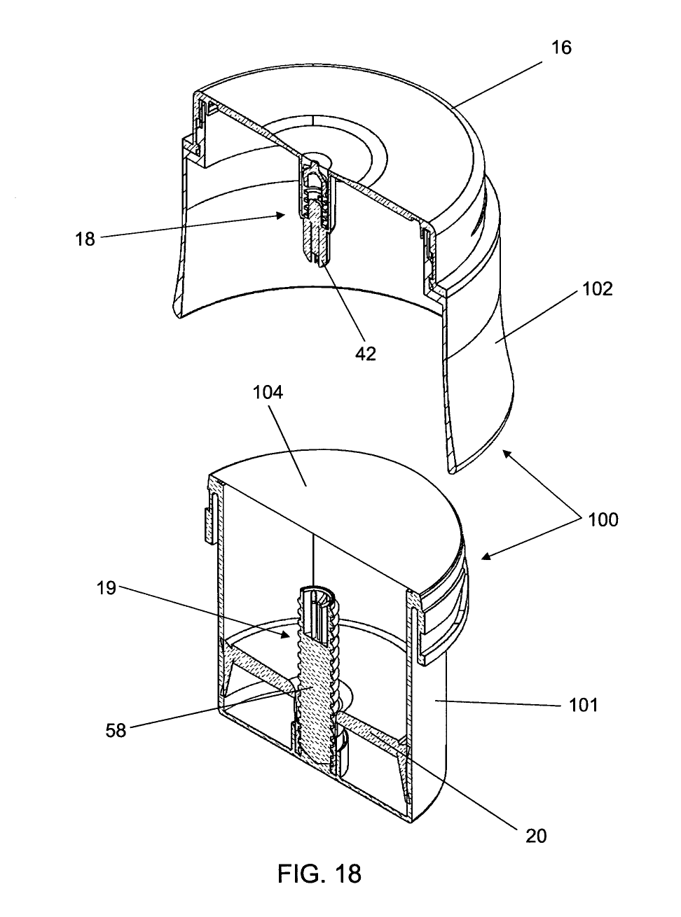

In another constructive variation of the system, the packaging in question, aims to reduce its environmental impact, including details to be a product partially disposable and reusable, for that it includes means for substitution of the cup-like recipient or the empty reservoir by a full cup-like recipient or reservoir, this last constitutes a refill which includes the cup-like recipient (101), the piston (20) and its screwed-rod (58), such as illustrated in FIGS. 15, 16, 17 and 18 where it shows that the set comprehends a modified body (100), composed by two independent pieces, being the first the cup-like recipient (101) preferably externally cylindrical and internally slightly oval, containing the product to be dispensed, while the second is a finishing cover or skirt (102), inside which inner part is placed the cup-like recipient (101), being that, for such, both have their ends endowed with means for fast coupling and uncoupling (103) cooperating to the set (FIG. 18) defined by said cup-like recipient (101) with the piston (20) and the screw-rod (58) (empty refill) may be removed and discarded, in order to be substituted by another equal set (full refill), and, in this case, the cup-like recipient (101) is temporarily sealed by a removable seal (104), which removal occurs manually in the moment prior to the refill is coupled in the inner portion of the cover (102) and, in this moment, that point (42) penetrates on the upper opening (59) of screw-rod (58) already assembled to the piston (20) inside the cup-like recipient (101) and consequently, the set is ready to be reused such as previously described, once the valve system (18) and the actioning mechanism (19) are exactly the same for the refill version.

In a preferred construction of the refill version, the means for fast coupling and uncoupling (103) are preferably constructed in a bayonet-like form, in such, the cup-like refill recipient (101) and the cover (102) present in their top ends collars which adjust concentrically (105-106), where the collar (105) from the cover presents its internal side endowed with minimum two protrude radial bolts (107) oppositely placed from one another, while at the external side from the collar (106) of the cup-like refill recipient (101) presents a female coupling formed by channels with vertical inlet portions (108) connected to short horizontal portions (109), both cooperating for the penetration and reversible locking of the radial bolts (107), consequently, it is possible to couple or uncouple the cup-like refill recipient (101) from the under part the skirt (102) and at the same time it is possible to keep the hermetic sealing of the system when coupled.

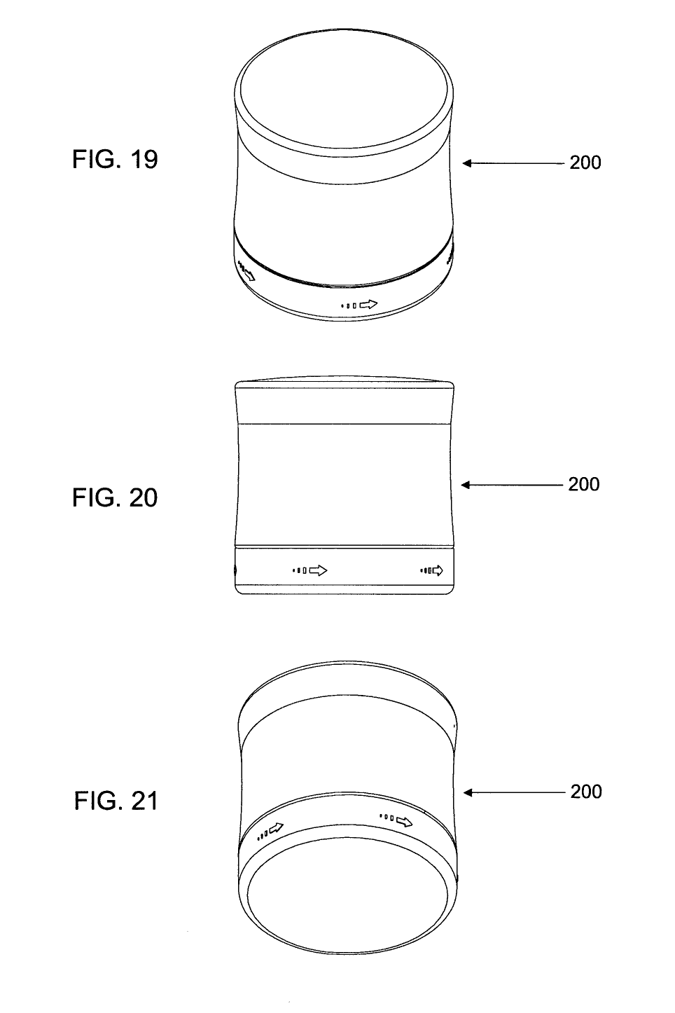

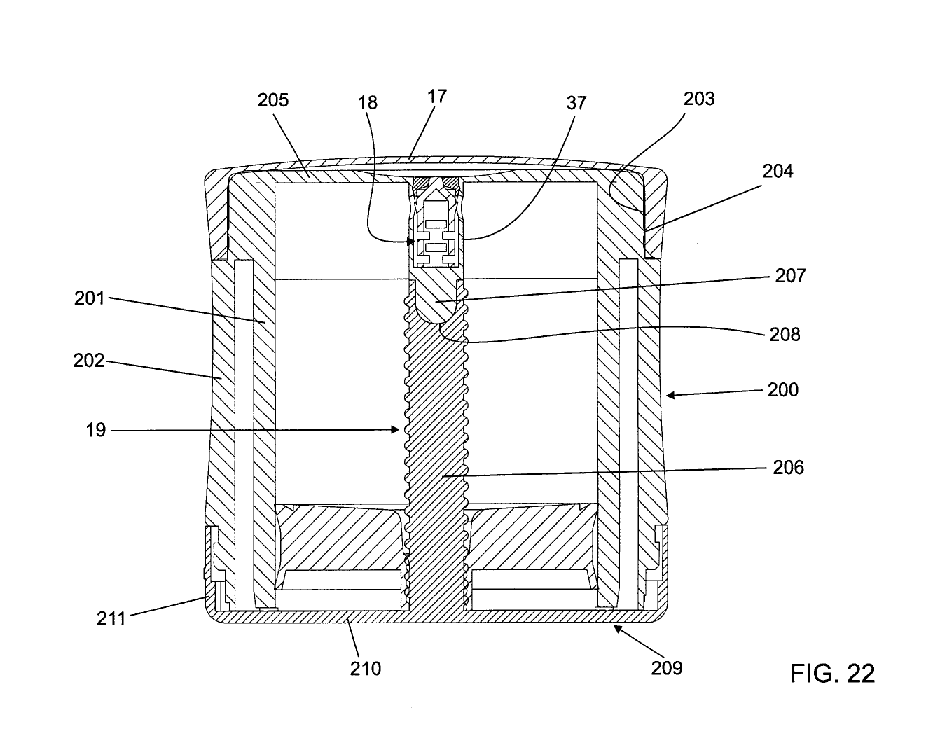

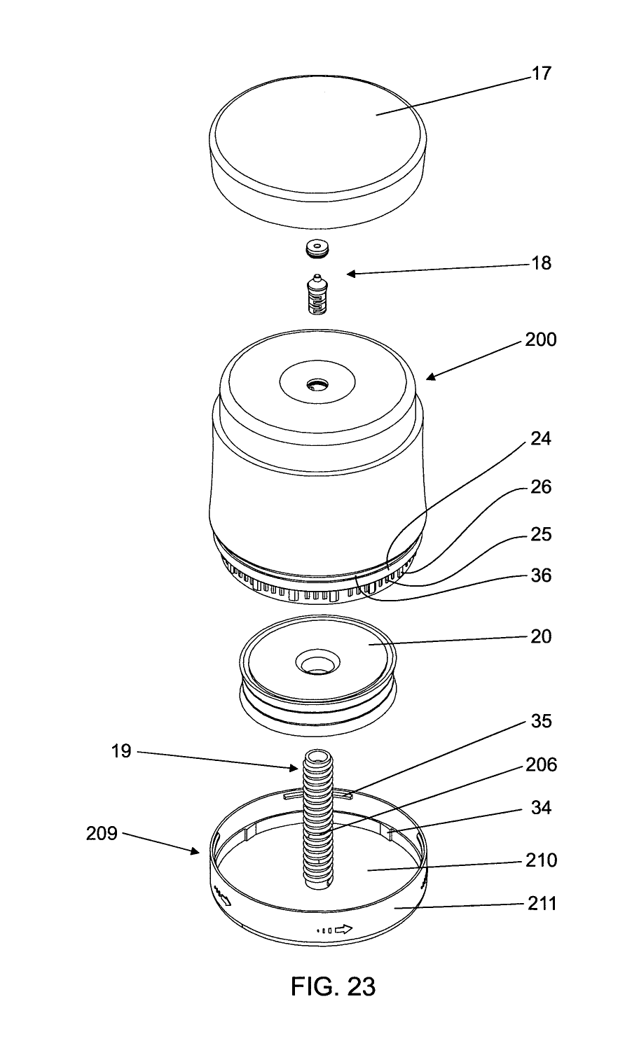

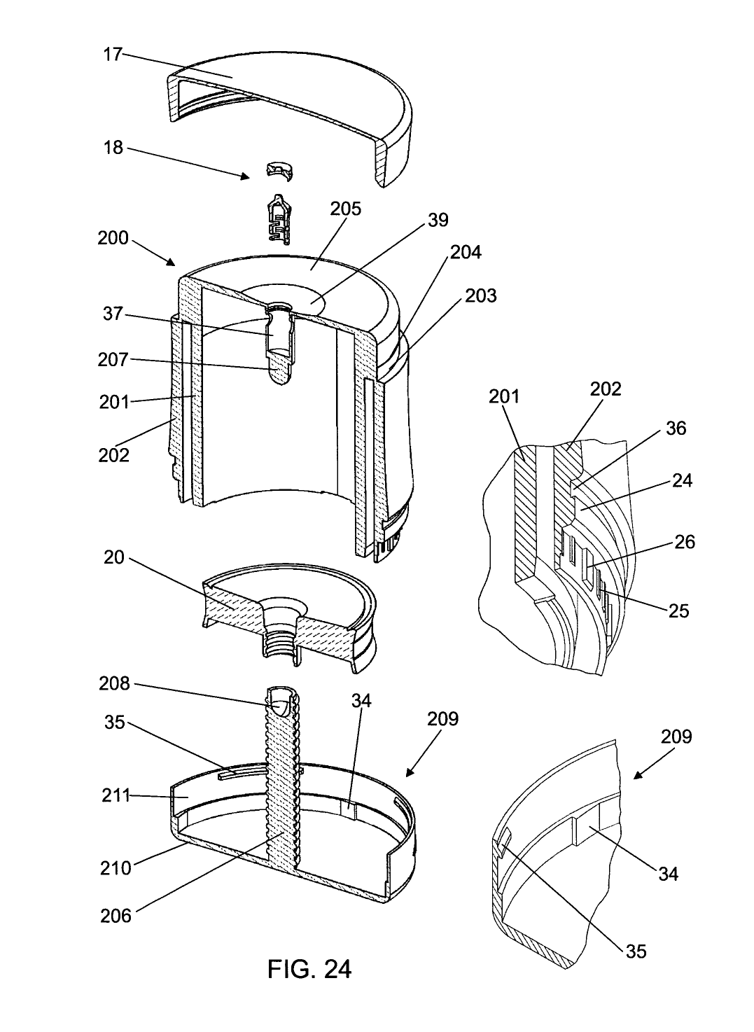

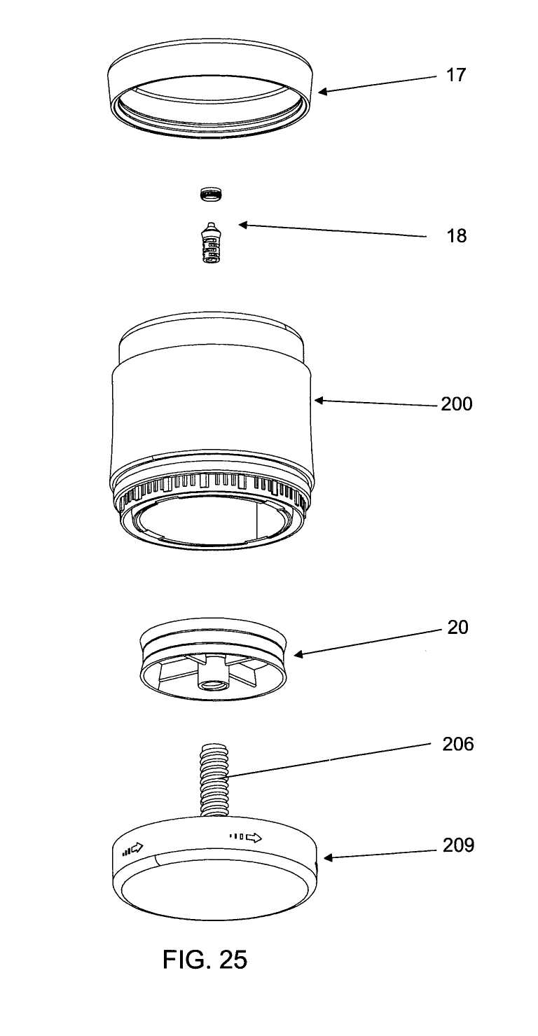

In a preferred constructive variation, illustrated in the FIGS. 19 to 25, the package in question presents its actioning mechanism assembled in the bottom part of the set (body), although keeping many constructive details of the previous versions since in this version occurs is the inversion of the actioning components, so that it is provided a modified body (200) in a sole piece formed by two parts, one being the cup-like recipient or reservoir (201) and the other the finishing cover (202), which top ends are integrated to each other and, in this point, exists an external diameter reduction (203) with coupling (204) details and a slight locking for the over-lid (17), as well as this part of the body (200) is closed by a top wall (205), in which central portion is positioned the protection dosing valve (18), that, by its turn is coupled with the actioning mechanism (19) and piston (20), being that, in this case, said actioning mechanism (19) has a modified screwed-rod (206), which modified top end is spin-coupled by male-female coupling define by a rounded bottom tip (207) which develops vertically down from the dosing chamber (37) and protection dosing valve (18), said tip which penetrates in the cavity (208) existing at the top end of the screwed-rod (206), which bottom end is integrated in a whole piece with a spinning base (209), practically in the shape of a spinning disc, having a back wall (210) and a circular skirt (211), in which, this last is coupled in a rotational form towards the external diameter of the skirt bottom end (202), where its rotation is equally accomplished step by step and always in the same plane in relation to the body (200), being that, for such, the external diameter of the skirt bottom end (202) has the same constructive details defined by the teeth (25-26), ring salience (24) and channel (36), over which act the coupling projections (35) and tabs (34) provided in the inner portion of the skirt (210) of the base (209), in a way that this last may be rotated (pace) and displace always in the same direction and in the same plane in relation to the main body (201), so that the piston (20) moves upwards generating enough pressure in the inner portion of the cup-like recipient (201) for the product dosage to be dispensed, such as described previously, through the dosing chamber (37) and through the dosing valve (18).

Therefore, the actioning mechanism of this version, although accomplished by the bottom of the package, is practically the same in relation to the previous versions, having as the basic difference the fact that the modified screwed-rod (206) is integrated with the base (209), where the turnstile system is also assembled.

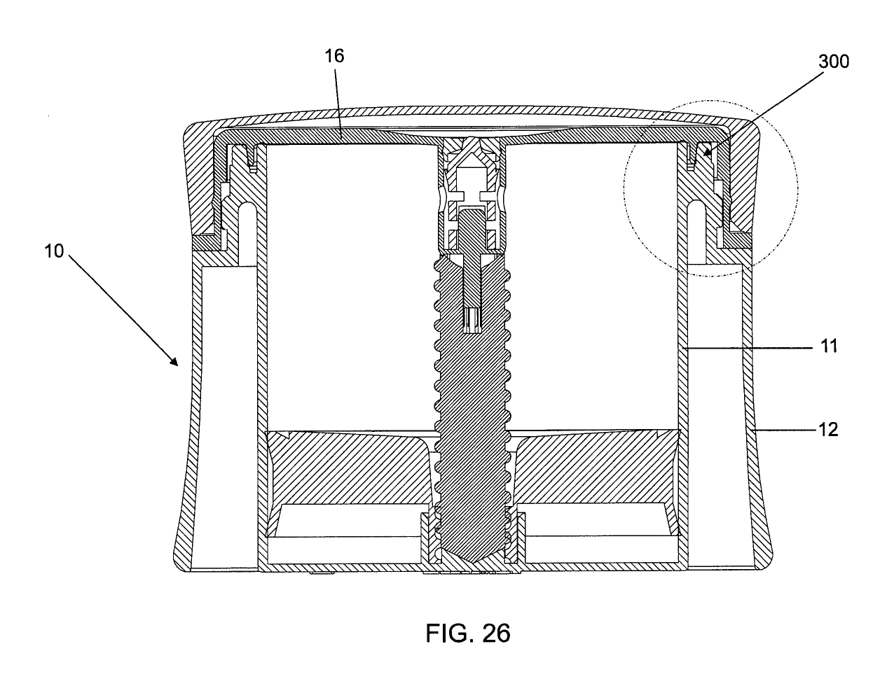

FIG. 26 illustrates a version of the package without the refill system and with a constructive variation for the sealing (300) between the spinning disc (16) and the body (10) which integrates the cup-like recipient (11) and the cover or skirt (12).

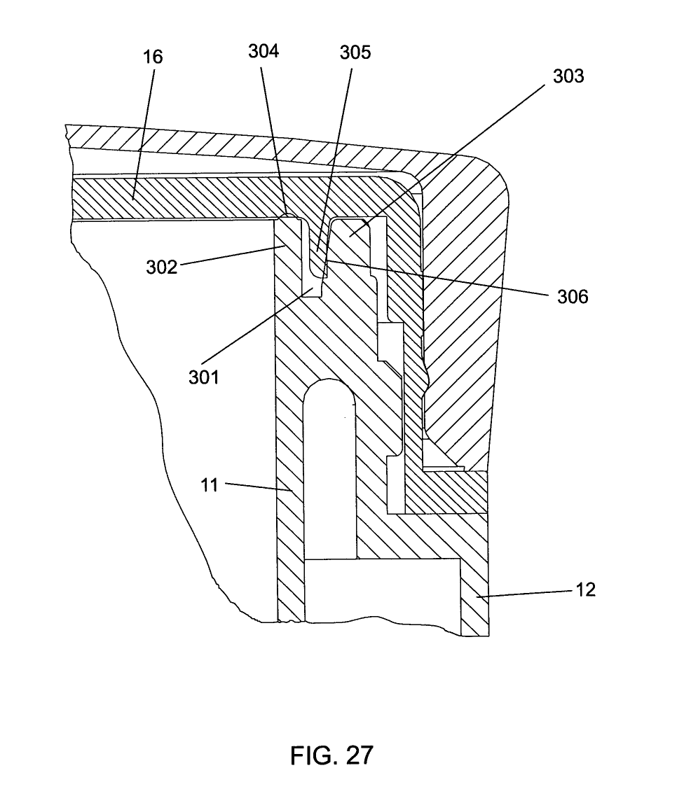

The sealing (300) is illustrated with details in the magnified FIG. 27, though which is possible to verify that such sealing is defined by an ordinarily modified groove in the shape of a “V” (301) configured on the top joining of the cup-like recipient (11) and the cover or skirt (12), such top which forms the concentric collars (302-303) modified, in which the inner one has a salience integrated that configures the sealing ring on the top part (304) over which is pressed the bottom surface of the spinning disc (16), that in this same face has a concentric cylindrical lip of reduced height (305), practically in the shape of a circular guide or trail, oriented to fit in the modified channel (301), which in face of its larger diameter (306) is slightly bent and against the lip (305) with a certain pressure or interference, and consequently, this coupling effect with interference granted by the sealing lip (305) at the groove (301) and the effect of the pressure between the top ring (304) and the bottom surface of the spinning disc (16) concurs to characterize an optimum hermetic sealing of the said spinning disc (16).

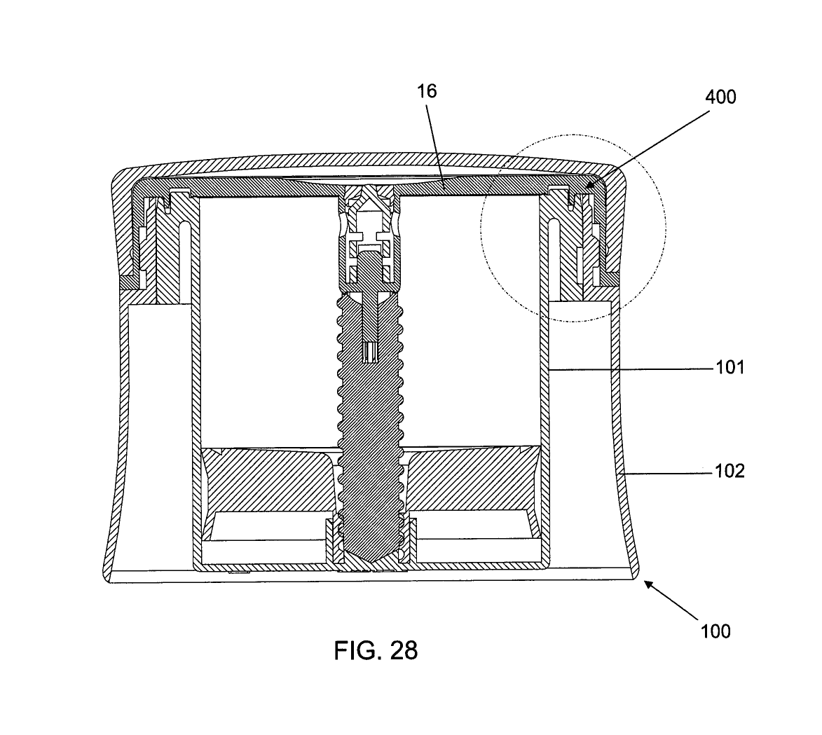

FIG. 28 illustrates the refill package version and with a constructive variation for the sealing (400) between the spinning disc (16) and the body (10) formed by the cup-like recipient (101) and the cover or skirt (102).

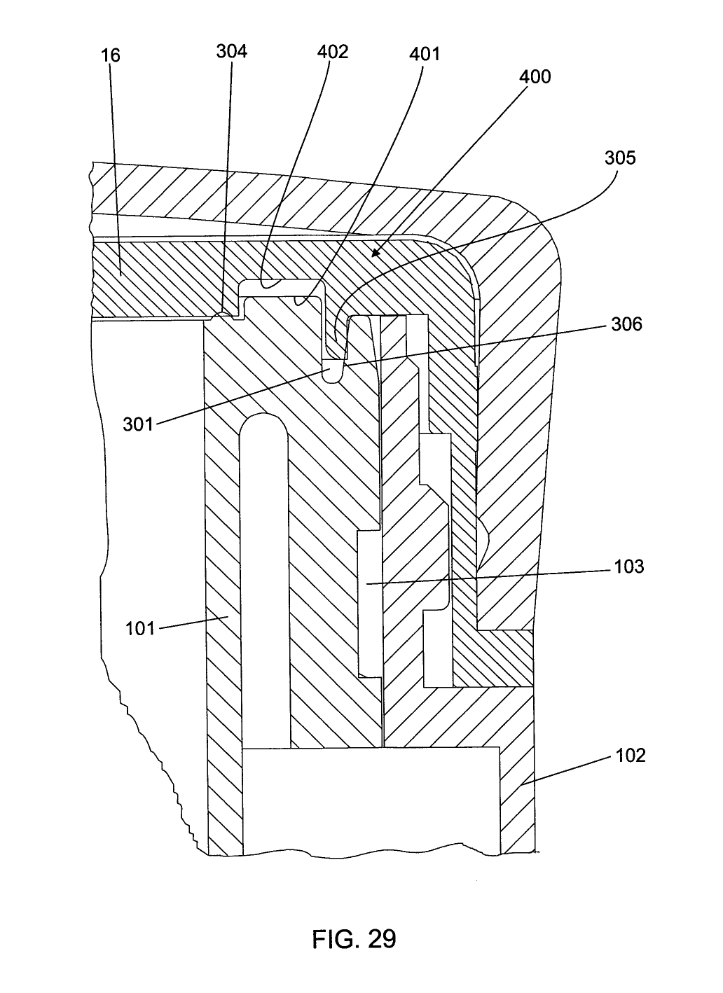

The seal (400) is illustrated with details in the FIG. 29, through which it is possible to verify that the sealing is equally achieved by the ordinarily modified groove in the shape of a “V” (301) and the sealing ring salience (304), both on the top part of the wall of the cup-like recipient (101), in which external diameter is coupled, through the engage (103) and the corresponding wall of the finishing cover or skirt (12), being that, between the channel (301) and the circular ring sealing salience (304), the top of the wall of the cup-like recipient (101) includes another ring salience which configures a male coupling (401) which penetrates without any interference in this female coupling point (402) existing in the bottom face of the spinning disc (16).

In this constructive version, the sealing effects occur in the same way, that is, over the ring salience (304) tensioned against the inferior surface of the spinning disc (16), while the lip (306) is oriented to penetrate the modified groove (301), which faces of major diameter (306) being slightly bent against with the said lip (305) maintaining a certain pressure or interference, consequently, this effect of coupling with interference granted by the sealing lip (305) at the groove (301) and the effect of the pressure between the ring top (304) and the bottom face of the spinning disc (16), concur to characterize an optimum hermetic sealing of the said spinning disc (16) in the refill version.

The male and female couplings (401-402) function like a guide trail during the disc spinning (16), keeping the whole set steady.

The tip of the salience (401) serves, as well, as a fixation area for a removable temporary seal (104), used to assure the tight sealing of the refill cup-like recipient (101), before it is coupled to the top portion of the system or cover (102).

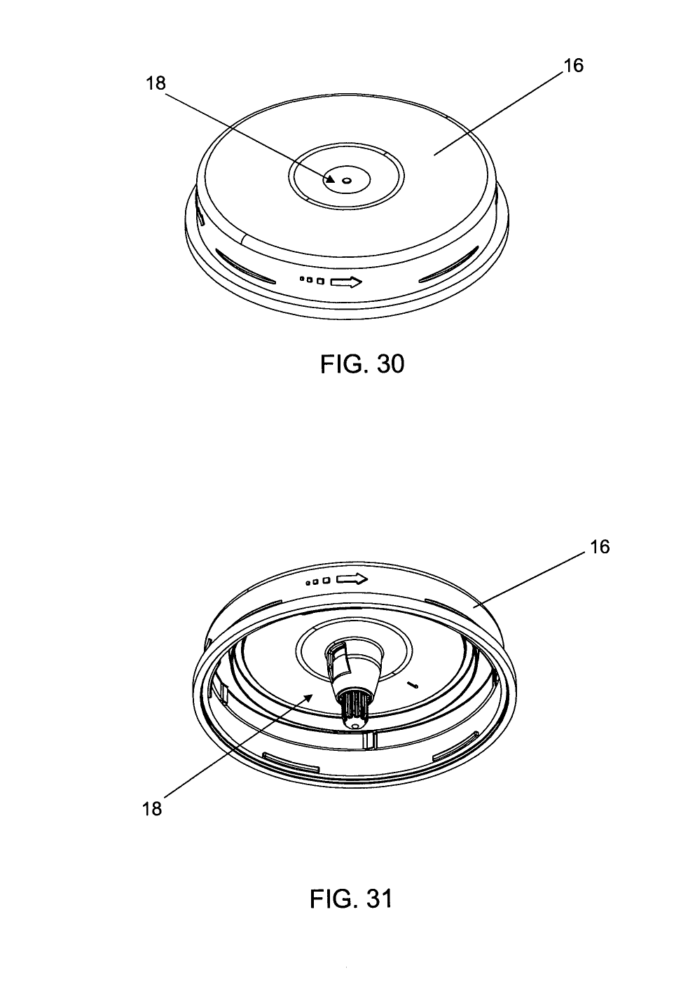

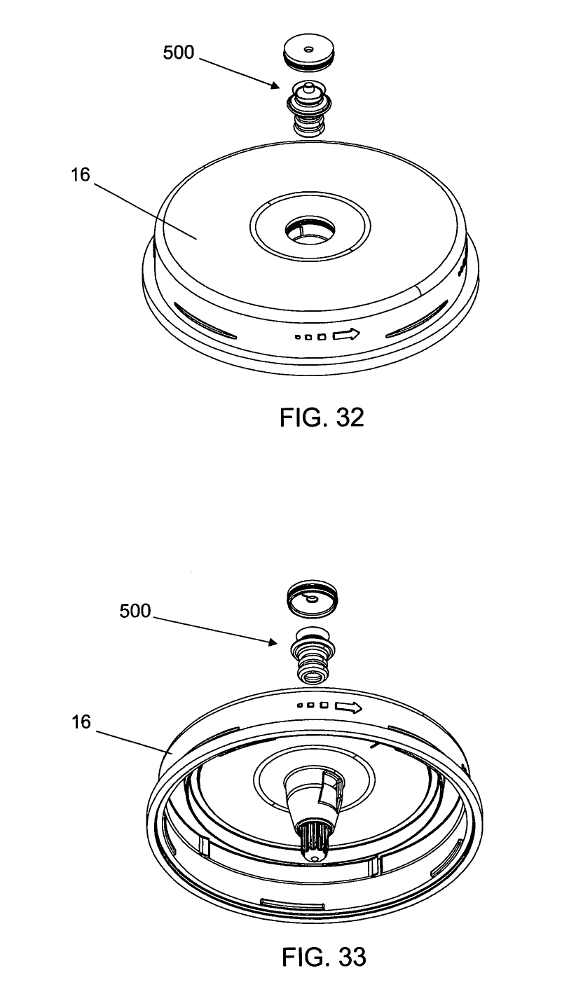

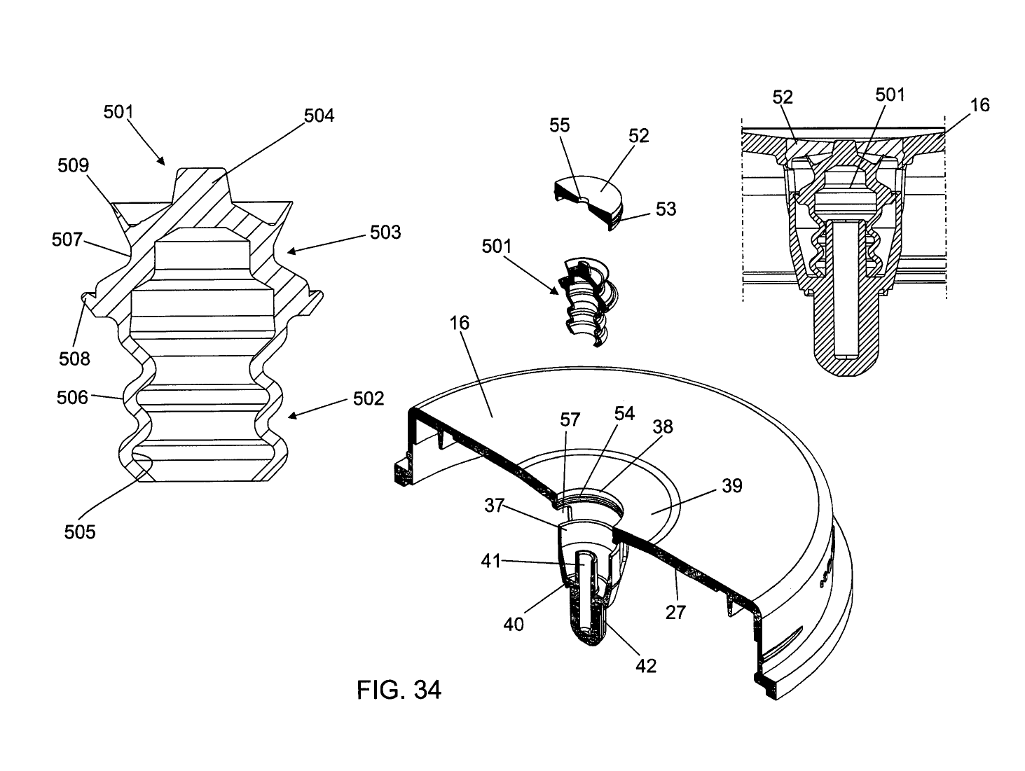

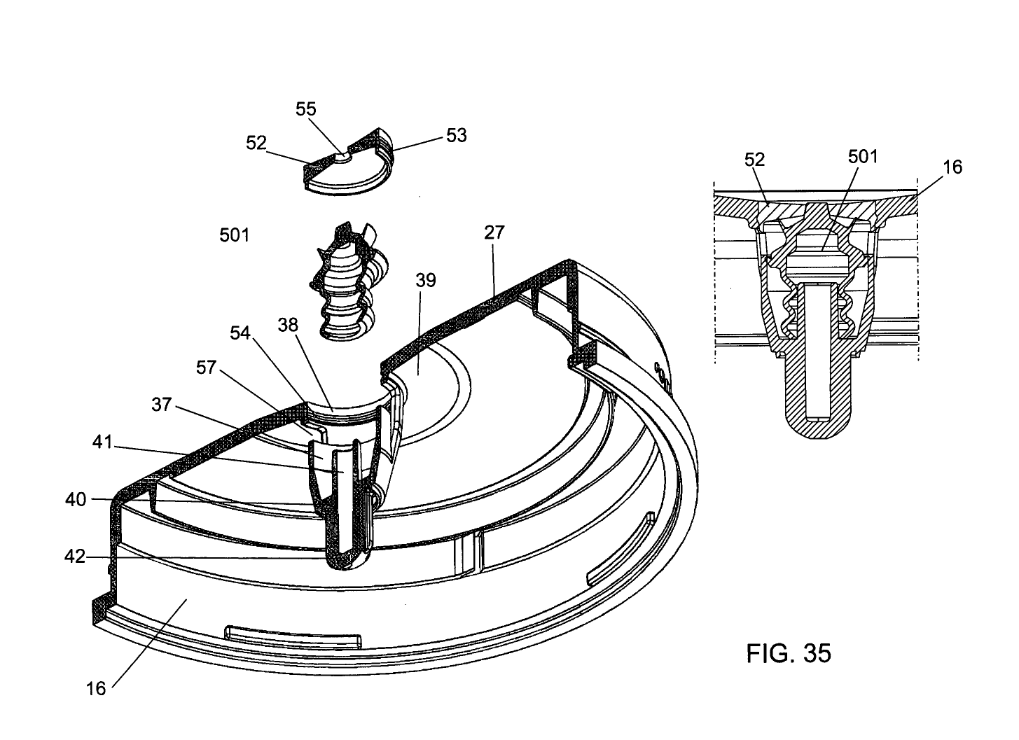

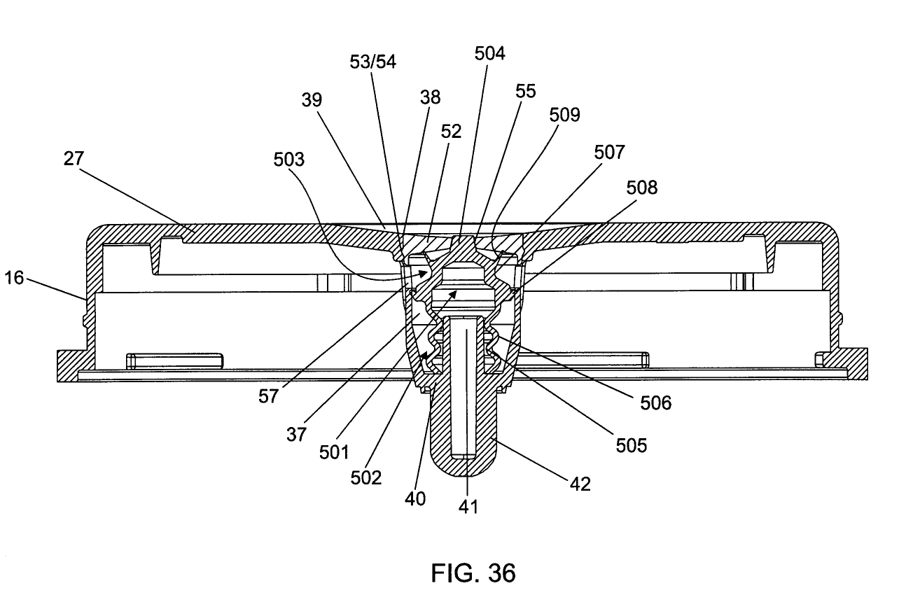

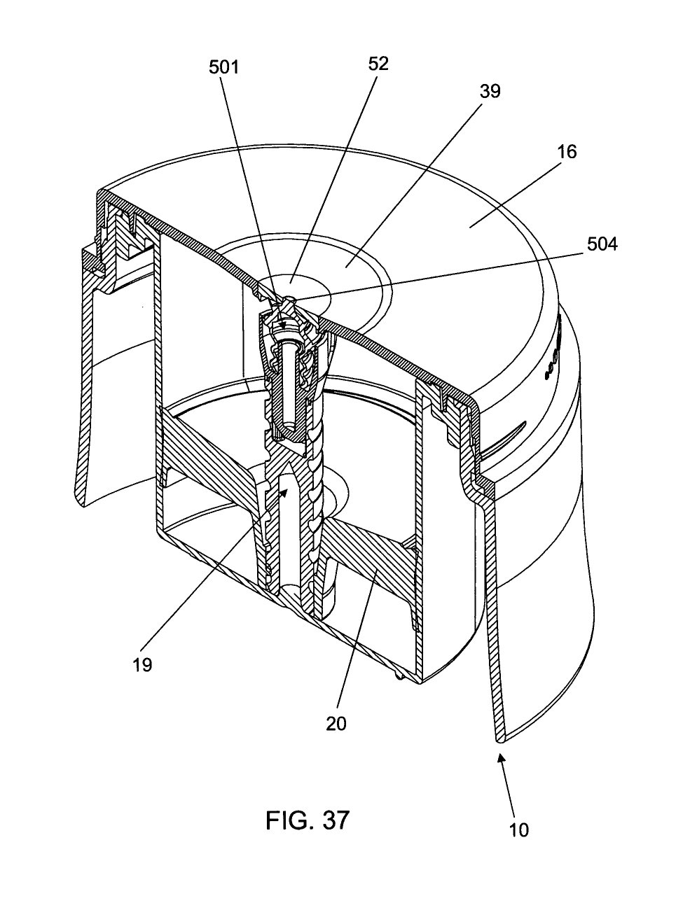

FIGS. 30 to 37 show constructive details of another preferred embodiment for the valve (18), maintaining the same drive in the form of a spinning disk (16), including the tubular dosing chamber (37), whose top end is entirely open and is integrated with the wall (27) of the spinning disk (16), configuring an opening (38) which, accordingly, is also circumscribed by a recess usually shaped in the form of a shell (39) for accumulation of the product's (P) dose, while through the bottom end of the dosing chamber tubular (37) Is completely sealed by a wall (40), which is centrally crossed by an integrated projection defined by two edges, one internal cylindrical on the top (41) and one external finned (42), the latter constituting a coupling for the actioning mechanism (19) of the piston (20), whereas the other (41) constitutes a coupling point for stabilizing a modified obturator (501), obtained from a suitable material substantially flexible in one sole piece which, in turn, is defined by three different parts, a bottom part with a spring-like function (502), an intermediary part having the function of a piston (503) and a top part with the function of a tip (504).

The bottom part with a spring-like function (502) is formed by an ordinary tubular section, however, with a corrugated profile defined by ring sectors with different diameters and which mutually alternate and agree by rounding such that said tubular wall may have a wave-like profile with points inwards (505) and outwards (506), which mutually combine to allow compression and expansion of said top part as if it were a helicoidal spring.

The top part of tip (504) is a tronconic edge designed to penetrate the sealing (52), whose external diameter has a circular locking fillet (53) which penetrates into an equally circular groove (54) existing in the internal diameter of the dosing chamber (37) and next to the opening (38), where said insert is locked, and same is also equipped with a central tronconic hole (55) for the product outlet, however, normally closed by the edge of the sealing top (504) pressed permanently upwards by way of the spring (502).

Said intermediary part referred to as a piston (503) is defined by a retreated and rounded bottleneck (507), whose ends have as limits two sealing lips, a bottom one (508) and a top one (509), wherein the first is slightly inclined and interferingly slides along the internal diameter of the dosing chamber (37) and below the openings (57), while the other lip (509) in the shape of a tronconic collar like a cornet pavilion, having a height sufficient to circumscribe and osculate the outlet (55) of the insert (52), wherein Said outlet opening (55) is normally kept closed in a Seal-tight manner by the tip (504), however, this sealing occurs such that between Said constructive details an access area can form for the product (P) which arrives to the inner part of the valve (18) through radial passages (57) existing at the wall of the dosing chamber (37), where the pressure of the product (P) overcomes the spring pressure (502) and makes the sealing tip (504) be displaced downwards releasing the nozzle (55) enough for one dose of the product (P) to be deposited on the recess (39), returning to close the outlet nozzle (55) immediately after the internal pressure is compensated through the dosage release.

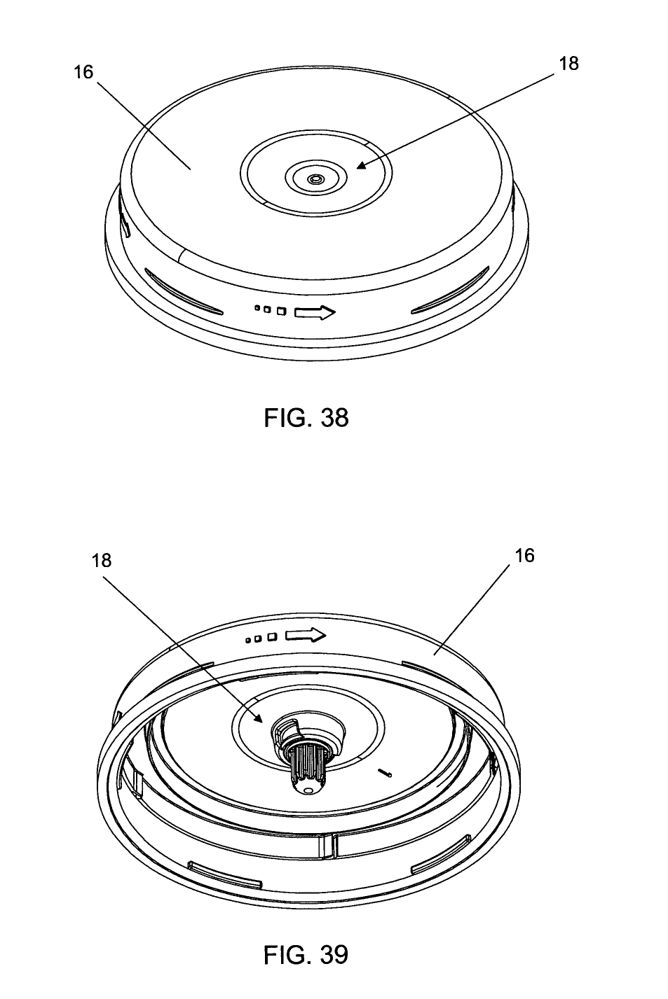

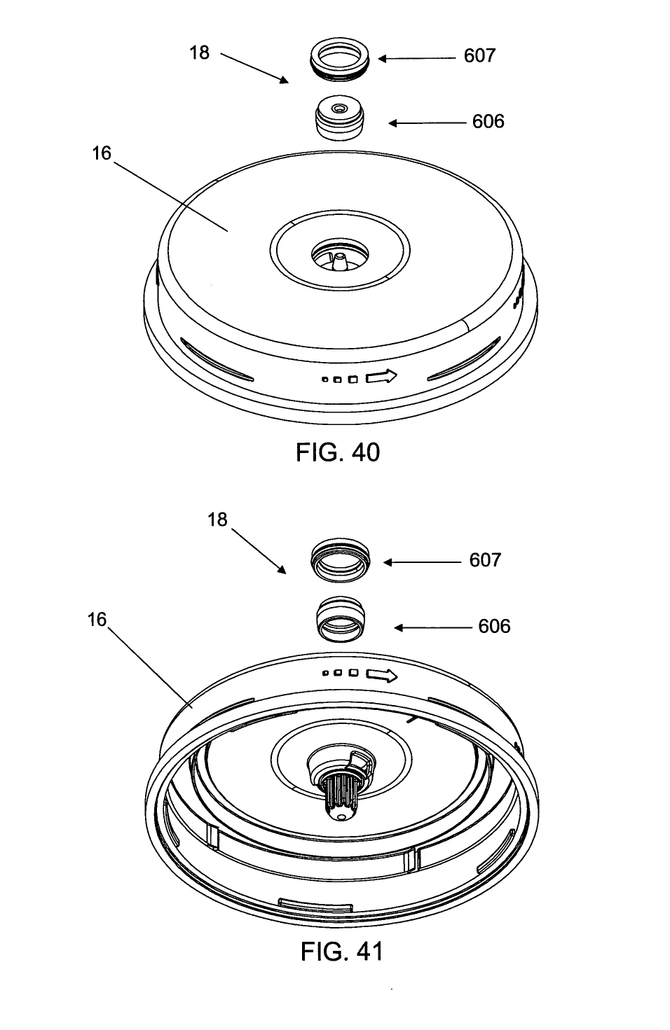

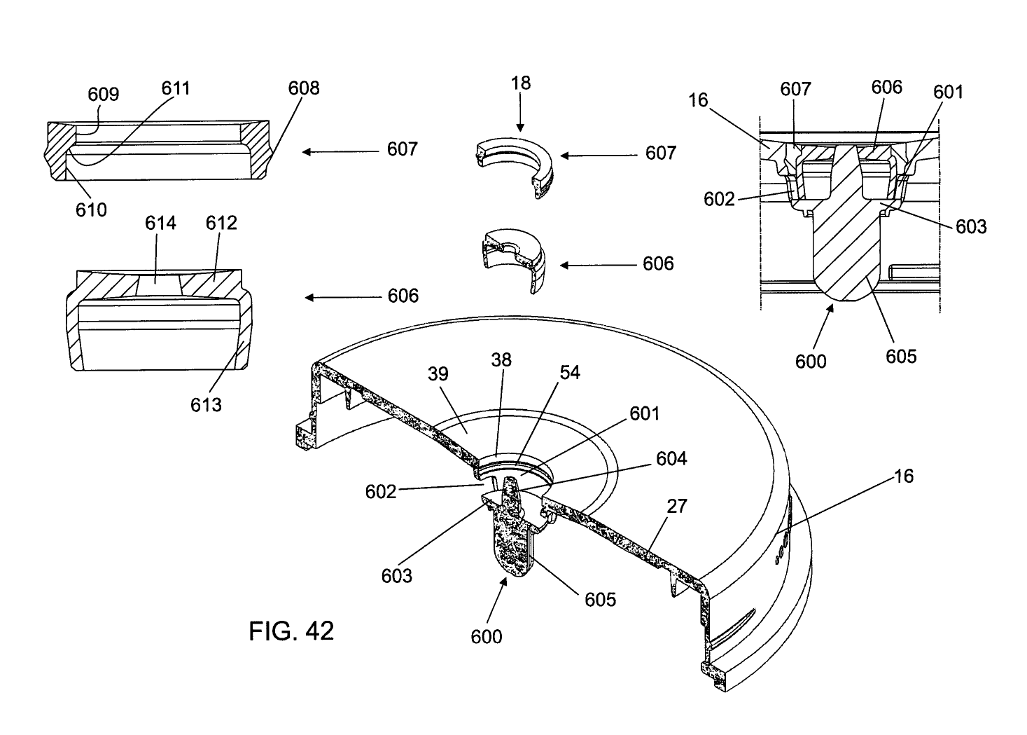

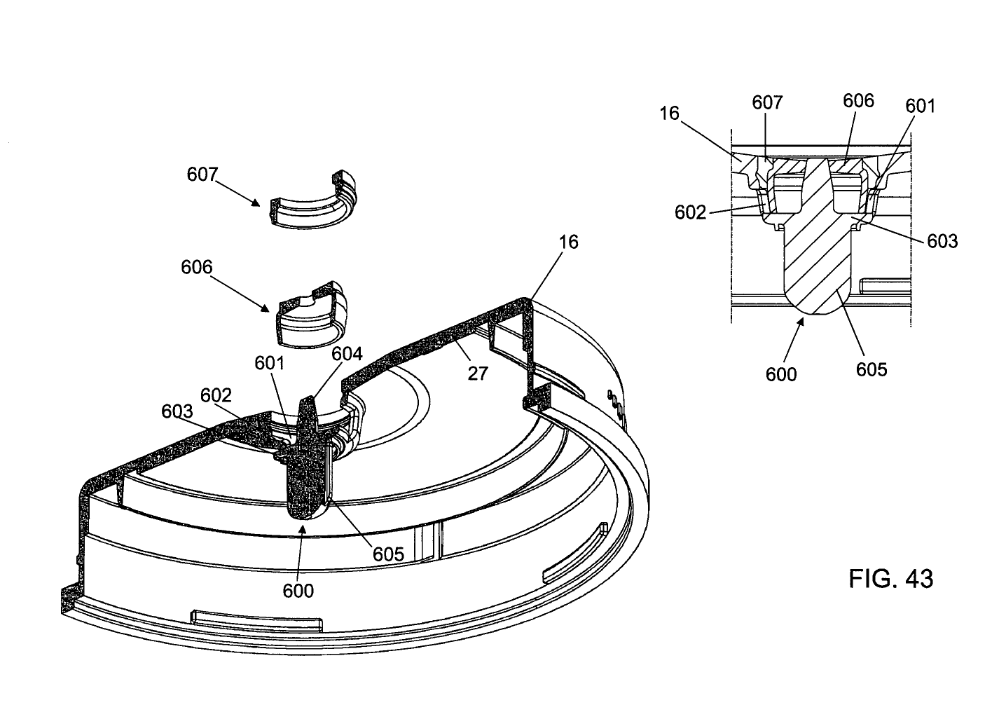

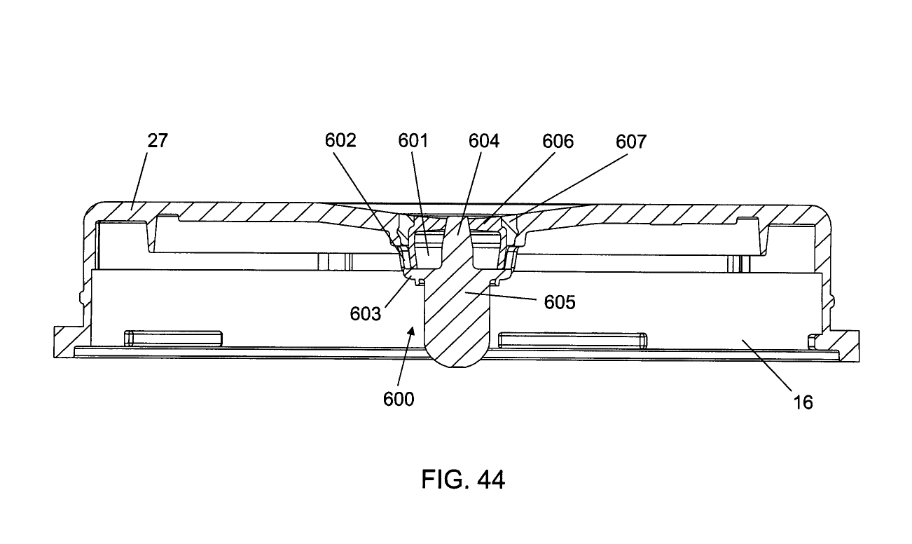

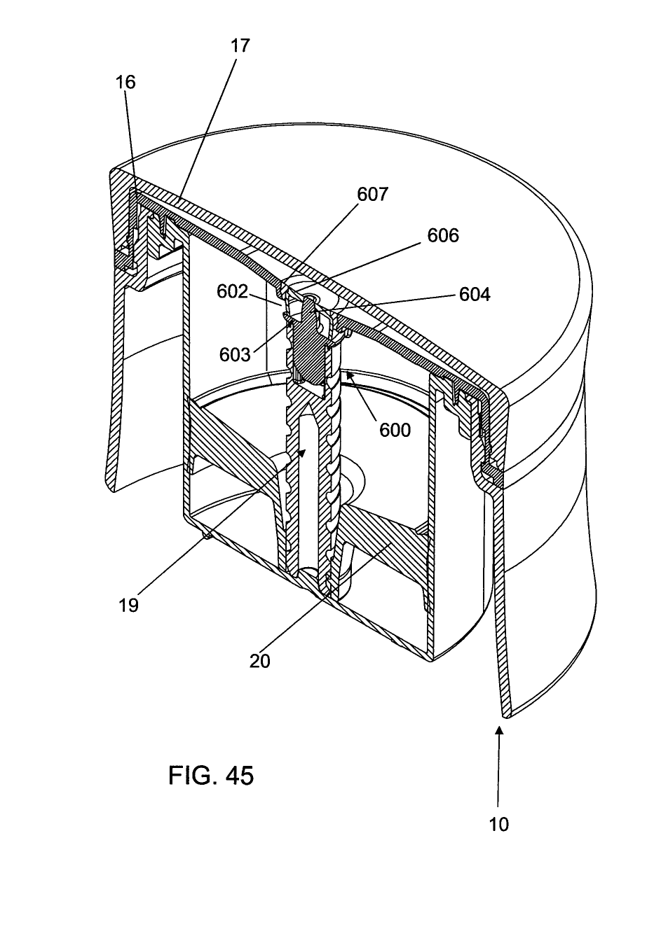

FIGS. 38 to 45 show constructive details of another preferred embodiment for the modified valve (600), maintaining the same drive in the form of a spinning disk (16), however, with significant modifications that begin in the dosing chamber ordinarily tubular (601) which, besides including side openings (602), is substantially reduced in height and has its end completely open and is integrated with the wall (27) of the spinning disk (16), configuring an opening (38) which, accordingly, is also circumscribed by a recess usually shaped in the form of a shell (39) for accumulation of the product's (P) dose, while through the bottom end the tubular dosing chamber (601) is completely closed by a wall (603), which is centrally crossed by an integrated projection defined by two edges, one internal in the form of fixed tip on the top (604) and one external finned on the bottom (605), the latter constitutes a coupling for the actioning mechanism (19) of the piston (20), while on the other (604), though a fixed tip, acts a substantially flexible obturator (606) and respective assembly ring (607), the latter with its external diameter having a circular fillet (608) for locking in the groove (54) of the actioning disk (16), where it is concentrically assembled, whereas the internal part of said assembly ring (607) is defined by two diameters, a smaller upper one (609) and a larger lower one (610), which mutually agree by way of a rounded corner (611), and this profile is defined by the two diameters and the intermediary step reflected in the external form of the flexible (606) which, accordingly, is shaped like an upturned cup, having an upper sealing wall (612) and a circular skirt (613), whose external parts, as already stated, define a geometry to lay perfectly against the internal profile of the ring (607) and, further, the skirt (613) has a height somewhat coinciding with the internal height of the chamber (601), where it also obstructs the openings (602) and, lastly, the wall (612) of said obturator has a central tronconic outlet hole (614), whose cone shape is appropriate for close-fitting and Seal-tight penetration of the fixed tip (604).

In this last constructive version the working of the obturator (606) equally depends on the pressure of the product (P), that is to say, when actioning the disk (16) the pressure created inside the packaging makes the product flow to the only outlet point defined by the openings (602) and, in this case, due to the flexibility of the obturator (606), the internal pressure causes temporary deformations therein, consequently, a small quantity of the product leaves by the interstices formed between the fixed parts of the valve and said flexible (606). This quantity of product accumulates in the part (39) as in the previous versions. Said interstices close immediately after compensation of the internal pressure with the release of the dosage.

It shall be understood that determined characteristics and combinations among the components that form the package may vary considerably, keeping always the same functional concept of a hermetic sealing and dosing mechanism for the set.

Consequently it is to be noted that the construction herein described in details as examples only, is clearly subject to constructive variations, although, always within the scope of the inventive concept disclosed herein.

The concept regards to a hermetic system which allows ejecting exact doses of the product within the inner portion of the package, and since a lot of modifications may be performed in the configuration herein detailed according to the descriptive demands of the law, it is understood that the present details shall be interpreted illustratively and not as a limitation.

1. PACKAGING ELEMENT WITH A HERMETICALLY SEALED DOSING MECHANISM FOR SEMI-SOLID PRODUCTS, characterized by the fact that it comprehends a body as a sole piece (10) injected in plastic material, configuring two concentric parts, one internal that configures the product containing cup-like recipient (11) and an external which configures a skirt for optional finishing (12), both with their top endings integrated between themselves by a horizontal wall (13), above which emerge vertically two concentric collars (14) and (15), which configure a hermetical coupling for a device in the shape of a spinning disc (16) that rotates in only one direction and always in the same plane in relation to the main body (10), and whose spinning disc (16) outside portion, may receive an optional over-lid (17), while from its inside portion has constructive details integrated to the assembly of an integrated protection dosing valve mechanism (18) and an actioning mechanism (19) for a piston (20) that, by its turn, initially (full package) is placed along with the bottom (21) of the cup-like recipient (11) containing the product (P), where said piston spinning is avoided by the fact that the internal diameter of the cup-like recipient (11) (FIG. 4) is slightly oval, although, said piston (20) is operatively assembled to be displaced only upwards upon activating the spinning disc (16) and, along with, the mechanism (19), in a way that the said piston may apply enough pressure to the product (P) placed above it, to open the protective dosing valve (18) and allow exact dosages of the product to be dispensed above the said spinning disc (16) on to a surface (39) where it can be removed with the fingers for application.

2. PACKAGING ELEMENT WITH A HERMETICALLY SEALED DOSING MECHANISM FOR SEMI-SOLID PRODUCTS, according to claim 1, characterized by the fact that both collars (14-15) present means for a hermetic coupling of the spinning disc (16) and means for the spinning disc to rotate always in the same plane in relation to the body (10) and only in one sense, preferably anti-clockwise. For that, initially the two collars (14-15) are enough concentrically apart one to the other to form a void (22), where the top edge of the internal collar (14) presents details of a circular closing ring in the shape of a top nervure (23a) and a cut (23b) placed in ramp towards the interior of the void (22), while the other external collar (15) presents in its external diameter two details in which the first one is a circular ring protrude (24), like a flange, above which there is a collar of smaller equidistant teeth (25) spaced apart in groups by other similar teeth, although larger (26), configuring a rotational turnstile control for advance of the spinning disc (16), that is turned, by the horizontal superior wall (27) an the a vertical cylindrical skirt (28), this last, having its bottom edge projected outwards in the shape of a flange (29) with diameter to lay on that portion of the wall (13), and, still, on the diameter of the said spinning disc (16) there are smooth locking fillets (30) for the seating of an optional over-lid (17) which, by the internal side of its skirt (31) it has a continuous smooth coupling groove (32) to seat on said filets (30) of the spinning disk (16) which, still, has two details for hermetic closing, in which, the first is a concentric cylindrical lip of reduced height practically in the shape of a circular guide, or track (33), which diameter is something to penetrate with interference in the void (22) and to be tensioned over the cut (23b), while at the second point of hermetic closing the bottom surface of the spinning disc (16) makes a certain pressure on the circular closing ring or top nervure (23a) located on the upper part of the collar (14), allowing an hermetic coupling for its closure type spinning disc.
The spinning disc (16) presents other internal details constituted by a collar of flexible equidistant tabs (34), slightly bent and oriented to slide on a carriage formed by the teeth (25) and (26) such sliding occurs in only one direction, since in the contrary sense, the edge of the tabs have the teeth (25-26) as barriers, being that, still in the internal portion of the spinning disc (16) includes a collar of coupling projections (35) with a trapezoidal transversal section dimensioned and oriented to be inserted in the groove (36) formed between the ring salience (35) and that wall (13), establishing, in this way a sliding coupling for the spinning disc (16), in a way that it is kept permanently over pressured against the body (12), as well as being turned in only one direction, and always in the same plane in relation to the body (12) to secure its sealing.

3. PACKAGING ELEMENT WITH A HERMETICALLY SEALED DOSING MECHANISM FOR SEMI-SOLID PRODUCTS, according to claim 1, characterized by the fact that the dosing protection valve mechanism (18) is constituted by a tubular dosing chamber (37), which top end is completely opened and is integrated with the wall (27) of the spinning disc (16), configuring an opening (38) whose top portion is circumscribed by a recess ordinarily shaped in form of a shell (39) for accumulation of the product's (P) dose, while through the bottom end, the tubular dosing chamber (37) is completely sealed by a wall (40), which is centrally crossed by an integrated projection defined by two edges, one internal cylindrical on the top (41) and one external finned (42) on the bottom, this last one constitutes a coupling for the actioning mechanism (19) and the piston (20) while the other (41) constitutes a coupling point for stabilizing an obturator (43) which is formed in one sole piece defined by two parts, a bottom portion with a spring-like function (44) formed by a section ordinarily tubular (45) with several cuts (46) and a superior part defined as a sealing lid (47), having a section ordinarily cylindrical (48) which constitutes the top end of said spring (44), such cylindrical section has a collapsible sealing lip (49) which slides with interference (or tension) at the internal diameter of the dosing chamber (37), and above said sealing lip (49), the cylindrical section (48) has an accentuated narrowing with a conic-shape (50) which ends in a point equally conic (51), which is oriented to penetrate in a sealing insert (52), this last with its external diameter endowed with a circular locking fillet (53) which penetrates in a groove equally circular (54) existing in the dosing chamber internal diameter (37) and along with an opening (38) where said insert is firmly locked, as well as, equipped with a conic central nozzle (55) for the product outlet, although, normally closed by the tip of the sealing lid (51) permanently pressed upwards by the spring-like part (44), although such closing occurs in a way that between the sealing (49) and the lid (47), as well as above the sealing lip (49) forms an access area (56) for the product (P) which arrives to the inner part of the protection valve (18) through one or more radial passages (57) existing at the wall of the dosing chamber (37), where the pressure of the product (P) overcomes the spring pressure (44) and makes the sealing tip (51) to be temporarily displaced downwards releasing the nozzle (55) enough for one dose of the product (P) to be deposited on the recess (39), returning to close the outlet orifice nozzle (55) immediately after the internal pressure is compensated through the dosage release.

4. PACKAGING ELEMENT WITH A HERMETICALLY SEALED DOSING MECHANISM FOR SEMI-SOLID PRODUCTS, according to claim 1, characterized by the fact that the activating mechanism (19) is formed by a screwed-rod (58), which presents on its top part a short tubular section (59) having in its inner portion radial fins (60) in between which those others fins (42) located in the under center part of the spinning disc (16) penetrates, in a way that both screw-rod (58) and spinning disc (16) may be solitarily bonded while the bottom end of the said screwed-rod (58) has a conic shape (61) to lay over an equally centered projection with its top part shaped also in a conic manner (62), which is circumscribed by a short tubular portion (63) which emerges from the internal bottom wall (21) in the internal part (11) of the cup-like recipient where there is a anti-vacuum opening (64), being that, as already explained, next to the said bottom, the piston (20) is positioned, having it a central hole with an internal screw (65) elongated downwards to be coupled between the seat (62) and the wall (63) from where said piston (20) begins its upwards displacement and also, on its bottom portion radial bars (66) are placed for a balance structuring of its external diameter, where top and bottom edges form sealing lips (67-68) which remain permanently pressured against the internal diameter of the cup-like recipient (11) to ensure the hermetic sealing in this point.
Once the screwed-rod (58) is positioned with a some interference inside the internal screw (65) of the piston, the hermetic sealing of the system in this point is ensured with at least one complete turn of the screw (pace) while the system (package) is not activated (self-life), and with at least one or more complete turns of the screw (pace) when the system is once activated.
In this constructive configuration, the hermetic sealing is also ensured at this point by the fact that the filet of the screw-rod (58) is perfectly equal to the screw pace (65) in the center of piston (20).

5. PACKAGING ELEMENT WITH A HERMETICALLY SEALED DOSING MECHANISM FOR SEMI-SOLID PRODUCTS, according to claim 1, characterized by the fact that the finishing skirt or cover or support (12) of the cup-like recipient (11) illustrated in the previous Figures is an item which constructive details may vary considerably to define any decorative or utility design, as well as said finishing cover or skirt is optional, consequently, may be completely eliminated

6. PACKAGING ELEMENT WITH A HERMETICALLY SEALED DOSING MECHANISM FOR SEMI-SOLID PRODUCTS, according to claim 1, in another constructive variation of the system, the packaging in question, aims to reduce its environmental impact, including details to be a product partially disposable and reusable, for that it includes means for substitution of the cup-like recipient or the empty reservoir by a full cup-like recipient or reservoir, this last constitutes a refill which includes the cup-like recipient (101), the piston (20) and its screwed-rod (58), characterized by the fact that it comprehends a modified body (100), composed by two independent pieces, being the first the cup-like recipient (101) preferably externally cylindrical and internally slightly oval, containing the product to be dispensed, while the second is a finishing cover or skirt (102), inside which inner part is placed the cup-like recipient (101), being that, for such, both have their ends endowed with means for fast coupling and uncoupling (103) cooperating to the set (FIG. 18) defined by said cup-like recipient (101) with the piston (20) and the screw-rod (58) (empty refill) may be removed and discarded, in order to be substituted by another equal set (full refill), and, in this case, the cup-like recipient (101) is temporarily sealed by a removable seal (104), which removal occurs manually in the moment prior to the refill is coupled in the inner portion of the cover (102) and, in this moment, that point (42) penetrates on the upper opening (59) of screw-rod (58) already assembled to the piston (20) inside the cup-like recipient (101) and consequently, the set is ready to be reused.

7. PACKAGING ELEMENT WITH A HERMETICALLY SEALED DOSING MECHANISM FOR SEMI-SOLID PRODUCTS, according to claim 6, characterized by the fact that in a preferred construction of the refill version, the means for fast coupling and uncoupling (103) are preferably constructed in a bayonet-like form, in such, the cup-like refill recipient (101) and the cover (102) present in their top ends collars which adjust concentrically (105-106), where the collar (105) from the cover presents its internal side endowed with two protrude radial bolts (103/107) oppositely placed from one another, while at the external side from the collar (106) of the cup-like refill recipient (101) presents a female coupling formed by channels with vertical inlet portions (108) connected to short horizontal portions (109), both cooperating for the penetration and reversible locking of the radial bolts (107), consequently, it is possible to couple or uncouple the cup-like refill recipient (101) from the under part the skirt (102) and at the same time it is possible to keep the hermetic sealing of the system when coupled.

8. PACKAGING ELEMENT WITH A HERMETICALLY SEALED DOSING MECHANISM FOR SEMI-SOLID PRODUCTS, according to claim 1, characterized by the fact that, in one constructive variation, the actioning mechanism assembled in the bottom part of the set (body), although keeping many constructive details of the previous versions since in this version occurs is the inversion of the actioning components, so that it is provided a modified body (200) in a sole piece formed by two parts, one being the cup-like recipient or reservoir (201) and the other the finishing cover (202), which top ends are integrated to each other and, in this point, exists an external diameter reduction (203) with coupling (204) details and a slight locking for the over-lid (17), as well as this part of the body (200) is closed by a top wall (205), in which central portion is positioned the dosing valve (18), that, by its turn is coupled with the actioning mechanism (19) and piston (20), being that, in this case, said actioning mechanism (19) has a modified screwed-rod (206), which modified top end is spin-coupled by male-female coupling define by a rounded bottom tip (207) which develops vertically down from the dosing chamber (37) and protection dosing valve (18), said tip which penetrates in the cavity (208) existing at the top end of the screwed-rod (206), which bottom end is integrated in a whole piece with a spinning base (209), practically in the shape of a spinning disc, having a back wall (210) and a circular skirt (211), in which, this last is coupled in a rotational form towards the external diameter of the skirt bottom end (202), where its rotation is equally accomplished step by step and always in the same plane in relation to the body (200), being that, for such, the external diameter of the skirt bottom end (202) has the same constructive details defined by the teeth (25-26), ring salience (24) and channel (36), over which act the coupling projections (35) and tabs (34) provided in the inner portion of the skirt (210) of the base (209), in a way that this last may be rotated (pace) and displace always in the same direction and in the same plane in relation to the main body (201), so that the piston (20) moves upwards generating enough pressure in the inner portion of the cup-like recipient (201) for the product dosage to be dispensed, such as described previously, through the dosing chamber (37) and through the dosing valve (18).

9. PACKAGING ELEMENT WITH A HERMETICALLY SEALED DOSING MECHANISM FOR SEMI-SOLID PRODUCTS, according to claim 1, characterized by the fact that it comprehends a constructive variation for sealing (300) between the spinning disc (16) and the body (10) which integrates the cup-like recipient (11) and the cover or skirt (12), such sealing is defined by an ordinarily modified groove in the shape of a “V” (301) configured on the top joining of the cup-like recipient (11) and the cover or skirt (12), such top which forms the concentric collars (302-303) modified, in which the inner one has a salience integrated that configures the sealing ring on the top part (304) over which is pressed the bottom surface of the spinning disc (16), that in this same face has a concentric cylindrical lip of reduced height (305), practically in the shape of a circular guide or trail, oriented to fit in the modified channel (301), which in face of its larger diameter (306) is slightly bent and against the lip (305) with a certain pressure or interference,

10. PACKAGING ELEMENT WITH A HERMETICALLY SEALED DOSING MECHANISM FOR SEMI-SOLID PRODUCTS, according to claim 1, characterized by the fact that it comprehends a constructive variation for the seal (400) between the spinning disc (16) and the body (10) formed by the cup-like recipient (101) and by the cover or skirt (102) of the refill version, such seal (400) equally formed by the ordinarily modified groove in the shape of a “V” (301) and the sealing ring (304), both configured on the top part of the wall of the cup-like recipient (101), in which external diameter is coupled, through an engage (103), and the corresponding wall of the finishing cover or skirt (12), being that, between the channel (301) and the sealing salience (304), the top of the wall of the cup-like recipient (101) includes another ring salience which configures a coupling without male interference (401) which penetrates in the female coupling (402) existing in the bottom face of the spinning disc (16).

11. PACKAGING ELEMENT WITH A HERMETICALLY SEALED DOSING MECHANISM FOR SEMI-SOLID PRODUCTS, according to claim 1, characterized by the fact that, in another preferred construction for the valve (18), there is maintained the same drive in the form of a spinning disk (16), including the tubular dosing chamber (37), whose top end is entirely open and is integrated with the wall (27) of the spinning disk (16), configuring an opening (38) which, accordingly, is also circumscribed by a recess ordinarily shaped in the form of a shell (39) for accumulation of the product's (P) dose, while through the bottom end the tubular dosing chamber (37) is completely sealed by a wall (40), which is centrally crossed by an integrated projection defined by two edges, one internal cylindrical on the top (41) and one external finned (42), the latter constituting a coupling for the actioning mechanism (19) of the piston (20), whereas the other (41) constitutes a coupling point for stabilizing a modified obturator (501), obtained from a suitable material substantially flexible in one sole piece which, in turn, is defined by three different parts, a bottom part with a spring-like function (502), an intermediary part having the function of a piston (503) and a top part with the function of a tip (504); said bottom part with a spring-like function (502) is formed by an ordinarily tubular section, however, with a corrugated profile defined by ring sectors with different diameters and which mutually alternate and agree by rounding such that said tubular wall may have a wave-like profile with points inwards (505) and outwards (506), which mutually combine to allow compression and expansion of said part as if it were a helicoidal spring; said top part or tip (504) is a tronconic edge designed to penetrate the sealing insert (52), whose external diameter has a circular locking fillet (53) which penetrates into an equally circular groove (54) existing in the internal diameter of the dosing chamber (37) and next to the opening (38), where said insert is locked, and same is also equipped with a central tronconic hole (55) for the product outlet, however, normally closed by the edge of the sealing tip (504) pressed permanently upwards by way of the spring (502); said piston (503) is defined by a retreated and rounded bottleneck (507), whose ends have as limits two sealing lips, a bottom one (508) and a top one (509), wherein the first is slightly inclined and interferingly slides along the internal diameter of the dosing chamber (37) and below the openings (57), while the other lip (509) in the shape of a tronconic collar like a cornet pavilion, having a height sufficient to circumscribe and osculate the outlet (55) of the insert (52), wherein said outlet opening (55) is normally kept closed in a seal-tight manner by the tip (504), however, this sealing occurs such that between said constructive details an access area can form for the product (P) which arrives to the inner part of the valve (18) through radial passages (57) existing at the wall of the dosing chamber (37), where the pressure of the product (P) overcomes the spring pressure (502) and makes the sealing tip (504) be displaced downwards releasing the nozzle (55) enough for one dose of the product (P) to be deposited on the recess (39), returning to close the outlet nozzle (55) immediately after the internal pressure is compensated through the dosage release.

12. PACKAGING ELEMENT WITH A HERMETICALLY SEALED DOSING MECHANISM FOR SEMI-SOLID PRODUCTS, according to claim 1, characterized by the fact that, in another preferred construction, it includes a modified valve (600), maintaining the same drive in the form of a spinning disk (16), however, with significant modifications that begin in the dosing chamber ordinarily tubular (601) which, besides including side openings (602), is substantially reduced in height and has its top end completely open and is integrated with the wall (27) of the spinning disk (16), configuring an opening (38) which, accordingly, is also circumscribed by a recess ordinarily shaped in the form of a shell (39) for accumulation of the product's (P) dose (P), while through the bottom end the tubular dosing chamber (601) is completely closed by a wall (603), which is centrally crossed by an integrated projection defined by two edges, one internal in the form of fixed tip on the top (604) and one external finned on the bottom (605), the latter constitutes a coupling for the actioning mechanism (19) of the piston (20), while on the other (604), though a fixed tip, acts a substantially flexible obturator (606) and respective assembly ring (607), the latter with its external diameter having a circular fillet (608) for locking in the groove (54) of the actioning disk (16), where it is concentrically assembled, whereas the internal part of said assembly ring (607) is defined by two diameters, a smaller upper one (609) and a larger lower one (610), which mutually agree by way of a rounded corner (611), and this profile is defined by the two diameters and the intermediary step reflected in the external form of the flexible obturator (606) which, accordingly, is shaped like an upturned cup, having an upper sealing wall (612) and a circular skirt (613), whose external parts, as already stated, define a geometry to lay perfectly against the internal profile of the ring (607) and, further, the skirt (613) has a height somewhat coinciding with the internal height of the chamber (601), where it also obstructs the openings (602) and, lastly, the wall (612) of said obturator has a central tronconic outlet hole (614), whose cone shape is appropriate for close-fitting and seal-tight penetration of the fixed tip (604).
